(19) United States
(12) Patent Application Publication
(10) Pub. No.: US 2026/0175274 A1
(43) Pub. Date: Jun. 25, 2026

(54) METHOD FOR MANUFACTURING FORMED PRODUCT

(71) Applicant: FUTABA INDUSTRIAL CO., LTD., Okazaki-shi (JP)

(72) Inventor: Miki Kotani, Okazaki-shi (JP)

(21) Appl. No.: 19/424,414

(22) Filed: Dec. 18, 2025

(30) Foreign Application Priority Data
Dec. 24, 2024 (JP) 2024-227917

(51) Int. Cl. B21B 1/22

(52) U.S. Cl. CPC B21B 1/22

(57) ABSTRACT

A method for manufacturing a formed product includes: (i) bending a plate-shaped workpiece, which extends in a length direction of the formed product and has at least one through part formed therethrough, by roll forming to form at least one ridge part on the workpiece such that the at least one ridge part overlaps the at least one through part; (ii) cutting the workpiece, which has the at least one ridge part formed thereon, along a cutting plane intersecting the length direction through the at least one through part, thereby obtaining an intermediate formed product having a main body part and at least one end piece part facing the at least one through part from a direction perpendicular to the length direction; and (iii) bending the at least one end piece part to form at least one flange part on the intermediate formed product, thereby obtaining the formed product.

### CROSS-REFERENCE TO RELATED APPLICATIONS

The present application claims the benefit of Japanese Patent Application No. 2024-227917 filed on Dec. 24, 2024 with the Japan Patent Office, the entire disclosure of which is incorporated herein by reference.

### BACKGROUND

The present disclosure relates to a method for manufacturing a formed product.

For example, Japanese U.S. Pat. No. 7,526,364 describes a battery case mounted on a vehicle. Inside the battery case, a cross member is disposed. The cross member is a plate-shaped member extending in a vehicle width direction. The cross member has a ridge part formed along the vehicle width direction. The ridge part forms a ridge line of plate-shaped parts adjacent to each other via the ridge part. Both ends of the cross member are fixed to the inner wall of the battery case.

Japanese U.S. Pat. No. 7,526,364 describes a method for bending a plate material through roll forming to form the ridge part on the plate material, as a method for manufacturing the cross member.

### SUMMARY

However, in the cross member manufactured by the method described in Japanese U.S. Pat. No. 7,526,364, brackets were required to fix the both ends of the cross member to the inner wall of the battery case. It is desirable that the cross member can be fixed to the inner wall of the battery case without the brackets.

It is also desirable that formed products other than cross members, which have a main body part below, can be fixed to the inner wall of a battery case without brackets. The main body part herein is a plate-shaped part extending in a specified direction and having a ridge part formed substantially along the specified direction.

In one aspect of the present disclosure, a method for manufacturing a formed product, which can be fixed to miscellaneous members without brackets, is provided.

One aspect of the present disclosure is a method for manufacturing a formed product. The formed product comprises a main body part and at least one flange part. The main body part is plate-shaped. The main body part extends in a length direction of the formed product. The main body part has at least one ridge part formed along the length direction. The at least one flange part is provided at an end of the main body part in the length direction. The method for manufacturing the formed product comprises:
(i) bending by roll forming a plate-shaped workpiece extending in the length direction, which has at least one through part formed therethrough, to form at least one ridge part on the workpiece such that the at least one ridge part overlaps the at least one through part;
(ii) cutting the workpiece, which has the at least one ridge part formed thereon, along a cutting plane intersecting the length direction through the at least one through part, thereby obtaining an intermediate formed product having the main body part and at least one end piece part facing the at least one through part from a direction perpendicular to the length direction; and
(iii) bending the at least one end piece part to form the at least one flange part on the intermediate formed product, thereby obtaining the formed product.

With the configuration as above, the formed product can be obtained which can be fixed to miscellaneous members without brackets.

One aspect of the present disclosure may further comprise forming the at least one through part in the workpiece before bending the workpiece by roll forming. This configuration facilitates production of formed products different in dimensions in the length direction of the main body part.

In one aspect of the present disclosure, the workpiece may have multiple through parts arranged in a direction intersecting the length direction, as the at least one through part. The workpiece may also have multiple ridge parts formed such that each ridge part overlaps with one of the multiple through parts, as the at least one ridge part. Cutting the workpiece along the cutting plane overlapping the multiple through parts may produce the intermediate formed product. With the configuration as above, the formed product can be obtained that can be fixed to miscellaneous members without brackets.

One embodiment of the present disclosure may further comprise forming the multiple through parts as the at least one through part in the workpiece before bending the workpiece by roll forming. This configuration facilitates production of formed products different in dimensions in the length direction of the main body part.

In one aspect of the present disclosure, the workpiece may be high-tensile steel. This configuration enables the workpiece to be bent by roll forming, thereby producing a highly accurate formed product, making the formed product even more useful.

In one aspect of the present disclosure, the formed product may be a component mounted on a vehicle.

### BRIEF DESCRIPTION OF THE DRAWINGS

An example embodiment of the present disclosure will be described hereinafter with reference to the accompanying drawings, in which:

FIG. 1 is a schematic top view of a battery mounting structure;

FIG. 2 is a cross-sectional view of the battery mounting structure in FIG. 1 taken by a line II-II;

FIG. 3 is a partially enlarged view of the battery mounting structure viewed from diagonally above;

FIG. 4 is a perspective view of a cross member of a first embodiment;

FIG. 5 is a schematic diagram showing a punching process and a roll forming process in the first embodiment;

FIG. 6 is a perspective view of the workpiece during the punching process and the roll forming process in the first embodiment;

FIG. 7A is a schematic top view of the workpiece before a cutting process in the first embodiment;

FIG. 7B is a schematic top view of the workpiece after the cutting process in the first embodiment;

FIG. 8A is a perspective view of the workpiece before the cutting process in the first embodiment;

FIG. 8B is a perspective view of the workpiece after the cutting process in the first embodiment;

FIG. 9A is a schematic top view of the workpiece during a bending process in the first embodiment;

FIG. 9B is a schematic top view of the workpiece during the bending process in the first embodiment, showing the workpiece at a more advanced stage than in FIG. 9A;

FIG. 10A is a perspective view showing a first cutting end part before the bending process in the first embodiment;

FIG. 10B is a perspective view showing a second cutting end part before the bending process in the first embodiment;

FIG. 10C is a perspective view showing the first cutting end part after the bending process in the first embodiment;

FIG. 10D is a perspective view showing the second cutting end part after the bending process in the first embodiment;

FIG. 11 is a schematic perspective view of a cross member of a second embodiment;

FIG. 12A is a schematic front view of the workpiece after the punching process in the second embodiment;

FIG. 12B is a schematic perspective view of the workpiece after the roll forming process in the second embodiment;

FIG. 12C is a schematic perspective view of the workpiece after the cutting process in the second embodiment;

FIG. 12D is a schematic perspective view of the workpiece after the bending process in the second embodiment;

FIG. 13 is a schematic perspective view of a cross member of a third embodiment;

FIG. 14A is a schematic front view of the workpiece after the punching process in the third embodiment;

FIG. 14B is a schematic perspective view of the workpiece after the roll forming process in the third embodiment;

FIG. 14C is a schematic perspective view of the workpiece after the cutting process in the third embodiment;

FIG. 14D is a schematic perspective view of the workpiece after the bending process in the third embodiment;

FIG. 15 is a schematic perspective view of a cross member of a fourth embodiment;

FIG. 16 is a schematic front view of the workpiece after the punching process in the fourth embodiment;

FIG. 17A is a schematic side view of the workpiece before the roll forming process in the fourth embodiment;

FIG. 17B is a schematic side view of the workpiece during the roll forming process in the fourth embodiment;

FIG. 17C is a schematic side view of the workpiece during the roll forming process in the fourth embodiment, showing the workpiece at a more advanced stage than in FIG. 17B;

FIG. 17D is a schematic side view of the workpiece during the roll forming process in the fourth embodiment, showing the workpiece at a more advanced stage than in FIG. 17C;

FIG. 18A is a schematic perspective view of the workpiece after the roll forming process in the fourth embodiment;

FIG. 18B is a schematic perspective view of the workpiece after a welding process in the fourth embodiment;

FIG. 18C is a schematic perspective view of the workpiece after the cutting process in the fourth embodiment;

FIG. 18D is a schematic perspective view of the workpiece after the bending process in the fourth embodiment;

FIG. 19 is a schematic perspective view of a cross member of a fifth embodiment;

FIG. 20 is a schematic front view of the workpiece after the punching process in a fifth embodiment;

FIG. 21A is a schematic side view of the workpiece before the roll forming process in the fifth embodiment;

FIG. 21B is a side view of the workpiece during the roll forming process in the fifth embodiment;

FIG. 21C is a schematic side view of the workpiece during the roll forming process in the fifth embodiment, showing the workpiece at a more advanced stage than that shown in FIG. 21B;

FIG. 21D is a schematic side view of the workpiece during the roll forming process in the fifth embodiment, showing the workpiece at a more advanced stage than that shown in FIG. 21C;

FIG. 21E is a schematic side view of the workpiece during the roll forming process in the fifth embodiment, showing the workpiece at a more advanced stage than that shown in FIG. 21D;

FIG. 21F is a schematic side view of the workpiece during the roll forming process in the fifth embodiment, showing the workpiece at a more advanced stage than that shown in FIG. 21E;

FIG. 22A is a schematic perspective view of the workpiece after the roll forming process in the fifth embodiment;

FIG. 22B is a schematic perspective view of the workpiece after the welding process in the fifth embodiment;

FIG. 23A is a schematic perspective view of the workpiece after the cutting process in the fifth embodiment;

FIG. 23B is a schematic perspective view of the workpiece after the bending process in the fifth embodiment;

FIG. 24 is a schematic perspective view of a cross member of a sixth embodiment;

FIG. 25 is a schematic front view of the workpiece after the punching process in the sixth embodiment;

FIG. 26A is a schematic side view of the workpiece before the roll forming process in the sixth embodiment;

FIG. 26B is a side view of the workpiece during the roll forming process in the sixth embodiment ;

FIG. 26C is a schematic side view of the workpiece during the roll forming process in the sixth embodiment, showing the workpiece at a more advanced stage than that shown in FIG. 26B;

FIG. 26D is a schematic side view of the workpiece during the roll forming process in the sixth embodiment, showing the workpiece at a more advanced stage than that shown in FIG. 26C;

FIG. 26E is a schematic side view of the workpiece during the roll forming process in the sixth embodiment, showing the workpiece at a more advanced stage than that shown in FIG. 26D;

FIG. 26F is a schematic side view of the workpiece during the roll forming process in the sixth embodiment, showing the workpiece at a more advanced stage than that shown in FIG. 26E;

FIG. 27A is a schematic perspective view of the workpiece after the roll forming process in the sixth embodiment;

FIG. 27B is a schematic perspective view of the workpiece after the welding process in the sixth embodiment ;

FIG. 28A is a schematic perspective view of the workpiece after the cutting process in the sixth embodiment;

FIG. 28B is a schematic perspective view of the workpiece after the bending process in the sixth embodiment;

FIG. 29 is a schematic perspective view of a cross member of a variation; and

FIG. 30 is a perspective view of a cross member of a variation different from that in FIG. 29.

### DETAILED DESCRIPTION OF EXEMPLARY EMBODIMENTS

### 1. First Embodiment

### 1-1. Configuration of Battery Mounting Structure

A battery mounting structure 1 shown in FIG. 1 is a structure for mounting a battery B on a vehicle. The battery mounting structure 1 is provided in a lower part of the vehicle. The up-down, front-rear, and left-right directions indicated in FIGS. 1 to 3 refer to the respective directions when the battery mounting structure 1 is installed in the vehicle.

As shown in FIG. 1, the battery mounting structure 1 comprises a frame member 2, a cross member 3A, a lower cover member 4, and an upper cover member (not shown). FIG. 1 shows an example where the battery mounting structure 1 has two cross members 3A, but the number of cross members included in the battery mounting structure is not particularly limited. The battery mounting structure may, for example, have one cross member or may have multiple cross members.

The frame member 2 is a frame-like member. The frame member 2 has a front part 21, a rear part 22, a left side part 23, and a right side part 24. The front part 21, the rear part 22, the left side part 23, and the right side part 24 are elongated parts extending in a specified direction. The front part 21, the rear part 22, the left side part 23, and the right side part 24 extend, for example, in a straight line.

When the battery mounting structure 1 is installed in the vehicle, the front part 21 and the rear part 22 extend in the left-right direction of the vehicle. The rear part 22 is located further rearward of the vehicle than the front part 21. The front part 21 and the rear part 22 are spaced apart from each other. A distance between the front part 21 and the rear part 22, for example, varies depending on an overall length of the vehicle. Lengths of the front part 21 and the rear part 22 in the left-right direction of the vehicle, for example, vary depending on an overall width of the vehicle.

When the battery mounting structure 1 is installed in the vehicle, the left side part 23 and the right side part 24 extend in the front-rear direction of the vehicle. The left side part 23 couples a left end at the front part 21 to a left end at the rear part 22. The right side part 24 couples a right end at the front part 21 to a right end at the rear part 22. The left side part 23 and the right side part 24 are spaced apart from each other. A distance between the left side part 23 and the right side part 24 is, for example, varied in accordance with the overall width of the vehicle.

As shown in FIG. 4, the cross member 3A is an elongated member extending in a specified direction. Hereinafter, a direction in which the cross member 3A extends is referred to as “length direction D”. The length direction D is, for example, a direction extending in a straight line. In the following description and drawings, one side in the length direction D is denoted as a first side, and the other side is denoted as a second side. The same applies to a second embodiment and subsequent embodiments described later.

As shown in FIG. 1, the cross member 3A is arranged to couple the left side part 23 and the right side part 24. When the battery mounting structure 1 is installed in the vehicle, the length direction D, for example, aligns with the left-right direction of the vehicle. Both ends of the cross member 3A in the length direction D, namely two fixed end parts 32A and 33A described later, are fixed to the left side part 23 and the right side part 24, respectively. When multiple cross members 3A are arranged, the cross members 3A are spaced apart from each other. The cross member 3A will be described in further detail later.

The lower cover member 4 is a member covering a lower part of a space surrounded by the frame member 2. Although not shown, the upper cover member is a member covering an upper part of the space surrounded by the frame member 2.

When there is a single cross member 3A, the battery B is placed in at least one of the spaces between the front part 21 and the cross member 3A, and between the rear part 22 and the cross member 3A. When there are multiple cross members 3A, the battery B is placed in at least one of the following locations: between the front part 21 and the cross member 3A; between the rear part 22 and the cross member 3A; and between the cross members 3A.

### 1-2. Configuration of Cross Member

The cross member 3A is further described in detail by way of FIGS. 1 to 4. The cross member 3A is manufactured by forming the workpiece 5 described later. The cross member 3A is an example of a formed product.

As shown in FIG. 4, the cross member 3A comprises a main body part 31A, a first fixed end part 32A, and a second fixed end part 33A.

The main body part 31A is a plate-shaped part. The main body part 31A extends in the length direction D. The main body part 31A comprises a main body wall part 311, two side wall parts 312a and 312b, two main body flange parts 313a and 313b, and four ridge parts 314a to 314d. In the first embodiment, the two side wall parts 312a and 312b are referred to as the first side wall part 312a and the second side wall part 312b, respectively, for distinction. The two main body flange parts 313a and 313b are referred to as the first main body flange part 313a and the second main body flange part 313b, respectively, for distinction. The four ridge parts 314a to 314d are referred to as the first ridge part 314a, the second ridge part 314b, the third ridge part 314c, and the fourth ridge part 314d, respectively, for distinction.

The main body wall part 311 is a plate-shaped part extending in the length direction D. The main body wall part 311 is, for example, flat. The main body wall part 311 has two edges along the length direction D. The edges along the length direction D, in other words, are edges extending from the first side to the second side.

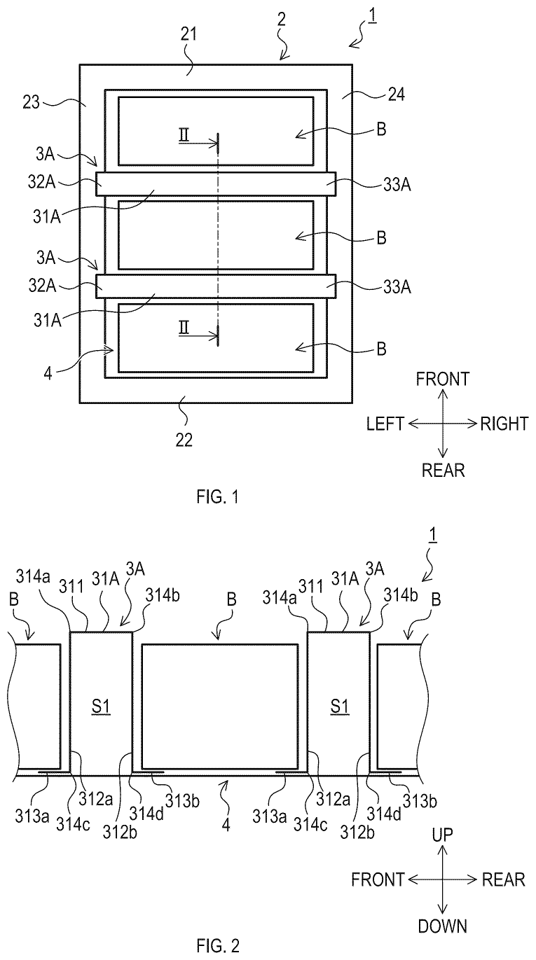

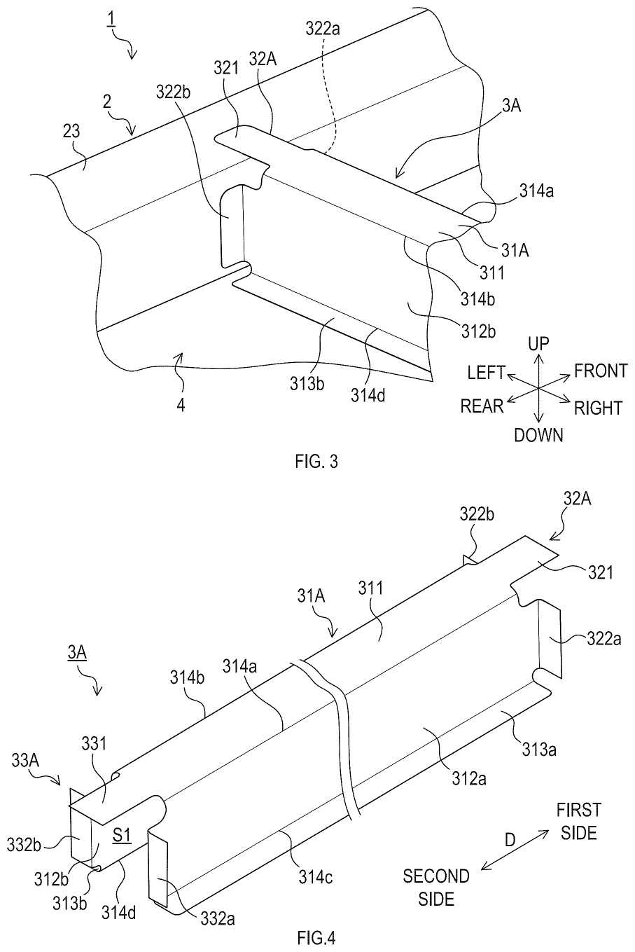

As shown in FIGS. 3 and 4, the first side wall part 312a and the second side wall part 312b are plate-shaped parts extending in the length direction D. The first side wall part 312a and the second side wall part 312b are, for example, flat. The first side wall part 312a is coupled to one of the two edges of the main body wall part 311 along the length direction D via the first ridge part 314a. The second side wall part 312b is coupled to the other of the two edges of the main body wall part 311 along the length direction D (in other words, the edge on the side opposite to the first side wall part 312a) via the second ridge part 314b. As shown in FIG. 2, the first side wall part 312a and the second side wall part 312b form an angle with respect to the main body wall part 311. A magnitude of the angle formed between the main body wall part 311 and either the first side wall part 312a or the second side wall part 312b is not particularly limited. This angle is, for example, 90°. The first side wall part 312a and the second side wall part 312b face each other at a distance.

As shown in FIGS. 3 and 4, the first ridge part 314a and the second ridge part 314b are plate-shaped parts extending in the length direction D. Cross sections perpendicular to the length direction D of the first ridge part 314a and the second ridge part 314b are curved in an arc shape. The first ridge part 314a and the second ridge part 314b each form a ridge line of plate-shaped parts adjacent with each other via the ridge part in a direction perpendicular to the length direction D. Specifically, the first ridge part 314a couples the main body wall part 311 and the first side wall part 312a, forming a ridge line therebetween. The second ridge part 314b couples the main body wall part 311 and the second side wall part 312b, forming a ridge line therebetween.

As shown in FIG. 2, the main body wall part 311, the first side wall part 312a, and the second side wall part 312b, together with the first ridge part 314a and the second ridge part 314b, form a region having a substantially U-shaped cross section perpendicular to the length direction D. Hereinafter, a space surrounded on three sides by the main body wall part 311, the first side wall part 312a, and the second side wall part 312b is referred to as an internal space S1. A side facing the internal space S1 relative to the main body wall part 311, the first side wall part 312a, and the second side wall part 312b is referred to as an inner side of the main body part 31A. A side opposite to the side facing the internal space S1 relative to the main body wall part 311, the first side wall part 312a, and the second side wall part 312b is referred to as an outer side of the main body part 31A. As shown in FIGS. 3 and 4, cross sections perpendicular to the length direction D of the first ridge part 314a and the second ridge part 314b are curved in an arc shape so that the first ridge part 314a and the second ridge part 314b bulge toward the outer side of the main body part 31A.

The first main body flange part 313a and the second main body flange part 313b are plate-shaped parts extending in the length direction D. The first main body flange part 313a and the second main body flange part 313b are, for example, flat.

As shown in FIG. 4, the first main body flange part 313a is continuous with an edge of the first side wall part 312a opposite to the main body wall part 311 via the third ridge part 314c. The first main body flange part 313a is disposed on the outer side of the main body part 31A relative to the first side wall part 312a. In other words, the first main body flange part 313a is disposed on an opposite side of the main body wall part 311 across the first side wall part 312a. As shown in FIG. 2, the first main body flange part 313a forms an angle with the first side wall part 312a. The first main body flange part 313a is, for example, parallel to the main body wall part 311. When the first main body flange part 313a is parallel to the main body wall part 311 and if an angle formed between the main body wall part 311 and the first side wall part 312a is 90°, then the angle formed between the first main body flange part 313a and the first side wall part 312a is also 90°.

As shown in FIG. 3, the second main body flange part 313b is continuous with an edge of the second side wall part 312b opposite to the main body wall part 311 via the fourth ridge part 314d. The second main body flange part 313b is disposed on the outer side of the main body part 31A relative to the second side wall part 312b. In other words, the second main body flange part 313b is disposed on an opposite side of the main body wall part 311 across the second side wall part 312b. As shown in FIG. 2, the second main body flange part 313b forms an angle with the second side wall part 312b. The second main body flange part 313b is, for example, parallel to the main body wall part 311. When the second main body flange part 313b is parallel to the main body wall part 311 and if an angle formed between the main body wall part 311 and the second side wall part 312b is 90°, then the angle formed between the second main body flange part 313b and the second side wall part 312b is also 90°.

As shown in FIGS. 3 and 4, the third ridge part 314c and the fourth ridge part 314d are plate-shaped parts extending in the length direction D. Cross sections perpendicular to the length direction D of the third ridge part 314c and the fourth ridge part 314d are curved in an arc shape. Specifically, the cross sections perpendicular to the length direction D of the third ridge part 314c and the fourth ridge part 314d are curved in an arc shape so as to bulge toward the inner side of the main body part 31A. The third ridge part 314c and the fourth ridge part 314d each form a ridge line of plate-shaped parts adjacent to each other via the ridge part in the direction perpendicular to the length direction D. Specifically, the third ridge part 314c couples the first side wall part 312a and the first main body flange part 313a, forming a ridge line therebetween. The second ridge part 314b couples the second side wall part 312b and the second main body flange part 313b, forming a ridge line therebetween.

As shown in FIG. 4, the first fixed end part 32A is provided at the first side end of the main body part 31A. The first fixed end part 32A includes an end piece part 321 and two end flange parts 322a and 322b. In the first embodiment, the two end flange parts 322a and 322b are referred to as the first end flange part 322a and the second end flange part 322b, respectively, for distinction. The end piece part 321, the first end flange part 322a, and the second end flange part 322b are, for example, flat.

The end piece part 321 extends further toward the first side from the first side edge of the main body wall part 311. The end piece part 321 forms a continuous plane with the main body wall part 311. There is no difference in level between the end piece part 321 and the main body wall part 311.

The first end flange part 322a extends from the first side edge of the first side wall part 312a toward the outer side of the main body part 31A. In other words, the first end flange part 322a extends away from the second side wall part 312b. The first end flange part 322a intersects the length direction D. The first end flange part 322a is, for example, perpendicular to the length direction D.

As shown in FIG. 3, the second end flange part 322b extends from the first side edge of the second side wall part 312b toward the outer side of the main body part 31A. In other words, the second end flange part 322b extends away from the first side wall part 312a. The second end flange part 322b intersects the length direction D. The second end flange part 322b is, for example, perpendicular to the length direction D.

As shown in FIG. 4, the second fixed end part 33A is provided at the second side end of the main body part 31A. The second fixed end part 33A has an end piece part 331 and two end flange parts 332a, 332b. In the first embodiment, the two end flange parts 332a and 332b are referred to as the first end flange part 332a and the second end flange part 332b, respectively, for distinction. The end piece part 331, the first end flange part 332a, and the second end flange part 332b are, for example, flat.

The end piece part 331 extends further toward the second side from the second side edge of the main body wall part 311. The end piece part 331 forms a continuous plane with the main body wall part 311. There is no difference in level between the end piece part 331 and the main body wall part 311.

The first end flange part 332a extends from the second side edge of the first side wall part 312a toward the outer side of the main body part 31A. In other words, the first end flange part 332a extends away from the second side wall part 312b. The first end flange part 332a intersects the length direction D. The first end flange part 332a is, for example, perpendicular to the length direction D.

The second end flange part 332b extends from the second side edge of the second side wall part 312b toward the outer side of the main body part 31A. In other words, the second end flange part 332b extends away from the first side wall part 312a. The second end flange part 332b intersects the length direction D. The second end flange part 332b is, for example, perpendicular to the length direction D.

As shown in FIG. 1, the cross member 3A is arranged to couple the left side part 23 and the right side part 24 in the frame member 2. As shown in FIG. 2, the cross member 3A is disposed such that the main body wall part 311 faces upward and the first main body flange part 313a and the second main body flange part 313b face downward. The first main body flange part 313a and the second main body flange part 313b are fixed to the lower cover member 4, for example, by welding.

As shown in FIG. 3, the first fixed end part 32A of the cross member 3A is fixed to the left side part 23 of the frame member 2. Specifically, the end piece part 321 is fixed to a top surface of the left side part 23, for example, by welding. The first end flange part 322a and the second end flange part 322b are fixed to a side surface of the left side part 23, for example, by welding.

As shown in FIG. 1, the second fixed end part 33A of the cross member 3A is fixed to the right side part 24 of the frame member 2. Although not shown, the end piece part 331 is fixed to a top surface of the right side part 24, for example, by welding. The first end flange part 332a and the second end flange part 332b are fixed to a side surface of the right side part 24, for example, by welding.

### 1-3. Method for Manufacturing Cross Member

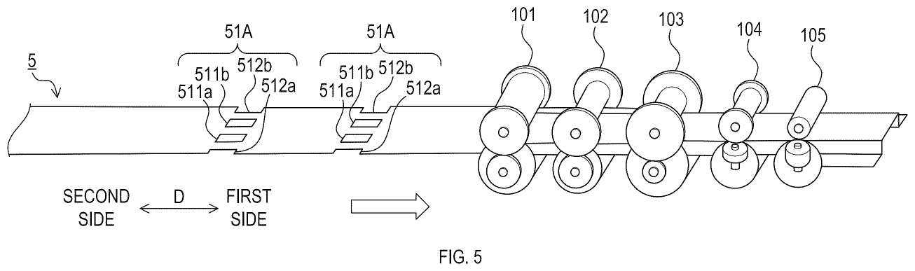

A method for manufacturing the cross member 3A is described by way of FIGS. 5 to 10D. The cross member 3A is manufactured from the workpiece 5 shown in FIG. 5. The workpiece 5 is a plate-shaped member extending in the length direction D. The workpiece 5 is, for example, flat. The workpiece 5 is made of metal. As one example, the workpiece 5 is high-tensile steel (so-called high-tensile material). High-tensile steel is steel with a tensile strength of at least 980 MPa or more, for example, 1180 MPa or higher. The workpiece 5 is, for example, high-tensile steel with a tensile strength of 1430 MPa.

The method for manufacturing the cross member 3A comprises a punching process, a roll forming process, a cutting process, and a bending process.

### 1-3-1. Punching Process

As shown in FIG. 5, during the punching process, at least one opening group 51A is formed in the workpiece 5 by a punching die (not shown). The opening group 51A includes at least one through part. The through part is an opening that penetrates the workpiece 5 in its thickness direction.

The opening group 51A of the first embodiment has, as at least one through part, two through holes 511a, 511b and two notches 512a, 512b. In other words, in the punching process of the first embodiment, at least one through part comprising two through holes 511a, 511b and two notches 512a, 512b is formed in the workpiece 5. In the first embodiment, the two through holes 511a and 511b are referred to as the first through hole 511a and the second through hole 511b, respectively, for distinction. The two notches 512a and 512b are referred to as the first notch 512a and the second notch 512b, respectively, for distinction.

The first through hole 511a and the second through hole 511b are openings in which edges of the workpiece 5 forming the through holes 511a and 511b are continuous along the entire circumferences surrounding the through holes 511a and 511b. The first notch 512a and the second notch 512b are openings in which edges of the workpiece 5 forming the notches 512a and 512b are not continuous along the entire circumferences of the notches 512a and 512b. In other words, the first notch 512a and the second notch 512b are openings each formed by cutting out a part of an edge of the workpiece 5. The first through hole 511a, the second through hole 511b, the first notch 512a, and the second notch 512b are aligned in a direction intersecting the length direction D (e.g., a direction perpendicular to the length direction D), in the order of the first notch 512a, the first through hole 511a, the second through hole 511b, and the second notch 512b.

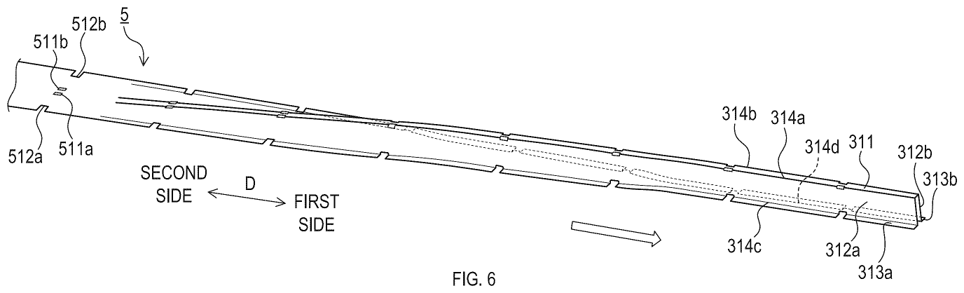

As indicated by white-filled arrows in FIGS. 5 and 6, the workpiece 5 is fed from the second side to the first side while being punched by the punching die. Multiple opening groups 51A are formed in the workpiece 5. The multiple opening groups 51A are spaced apart from each other in the length direction D. A distance between the opening groups 51A is equal to the dimension of the main body part 31A in the length direction D.

### 1-3-2. Roll Forming Process

As shown in FIG. 5, the roll forming process follows the punching process. In the roll forming process, roll forming is performed on the workpiece 5, which had the opening groups 51A formed during the punching process. The workpiece 5 is passed between multiple sets of forming rollers 101 to 105 and gradually bent as shown in FIG. 6. As a result, at least one ridge part is formed on the workpiece 5 along the length direction D. The at least one ridge part is formed to extend along the length direction D. The at least one ridge part is formed to overlap at least one through part. Overlapping of a specific ridge part with a specific through part means that at least a part of the edge of the workpiece 5 forming that specific through part is formed by that specific ridge part.

In the first embodiment, during the preceding punching process, the first through hole 511a, the second through hole 511b, the first notch 512a, and the second notch 512b are formed as at least one through part. Therefore, in the subsequent roll forming process, the workpiece 5 is bent by roll forming, forming the first to fourth ridge parts 314a to 314d on the workpiece 5.

More specifically, the workpiece 5 is bent by roll forming as described in steps (A-1) to (A-4) below.

(A-1) The workpiece 5 is bent such that a part corresponding to the first side wall part 312a forms an angle with a part corresponding to the main body wall part 311. When this bending is performed following or in parallel with the process described in step (A-2) below, it can also be said that the workpiece 5 is bent such that the part corresponding to the first side wall part 312a faces the part corresponding to the second side wall part 312b. By bending the workpiece 5 in step (A-1), the first ridge part 314a is formed on the workpiece 5. The first ridge part 314a is formed to overlap the first through hole 511a. The first ridge part 314a extends along the length direction D.

(A-2) The workpiece 5 is bent such that a part corresponding to the second side wall part 312b forms an angle with the part corresponding to the main body wall part 311. When this bending is performed following or in parallel with the above step (A-1), it can also be said that the workpiece 5 is bent such that the part corresponding to the second side wall part 312b faces the part corresponding to the first side wall part 312a. By bending the workpiece 5 in step (A-2), the second ridge part 314b is formed on the workpiece 5. The second ridge part 314b is formed to overlap the second through hole 511b. The second ridge part 314b extends along the length direction D.

(A-3) The workpiece 5 is bent such that a part corresponding to the first main body flange part 313a forms an angle with the part corresponding to the first side wall part 312a. At this time, the workpiece 5 is bent such that the part corresponding to the first main body flange part 313a does not face the part corresponding to the main body wall part 311. Bending the workpiece 5 in step (A-3) forms the third ridge part 314c on the workpiece 5. The third ridge part 314c is formed to overlap the first notch 512a. The third ridge part 314c extends along the length direction D.

(A-4) The workpiece 5 is bent such that a part corresponding to the second main body flange part 313b forms an angle with the part corresponding to the second side wall part 312b. At this time, the workpiece 5 is bent such that the part corresponding to the second main body flange part 313b does not face the part corresponding to the main body wall part 311. Bending the workpiece 5 in step (A-4) forms the fourth ridge part 314d on the workpiece 5. The fourth ridge part 314d is formed to overlap the second notch 512b. The fourth ridge part 314d extends along the length direction D.

The above steps (A-1) to (A-4) may be performed individually, or at least two of them may be performed in parallel. In the first embodiment, steps (A-1) and (A-2) are started simultaneously, and then steps (A-3) and (A-4) are also performed in parallel from a certain point during the execution of steps (A-1) and (A-2).

A part of the workpiece 5 interposed between the first ridge part 314a and the second ridge part 314b corresponds to the main body wall part 311. A part of the workpiece 5 interposed between the first ridge part 314a and the third ridge part 314c corresponds to the first side wall part 312a. A part of the workpiece 5 interposed between the second ridge part 314b and the fourth ridge part 314d corresponds to the second side wall part 312b. A part of the workpiece 5 continuous with the first side wall part 312a via the third ridge part 314c corresponds to the first main body flange part 313a. A part of the workpiece 5 continuous with the second side wall part 312b via the fourth ridge part 314d corresponds to the second main body flange part 313b. By forming the first to fourth ridge parts 314a to 314d in the workpiece 5, the main body wall part 311, the first side wall part 312a, the second side wall part 312b, the first main body flange part 313a, and the second main body flange part 313b are also formed in the workpiece 5. In other words, the main body part 31A is formed in the workpiece 5.

The roll forming process may be performed as a process continuous with the punching process, as shown in FIG. 5, or may be performed as a process independent of the punching process.

### 1-3-3. Cutting Process

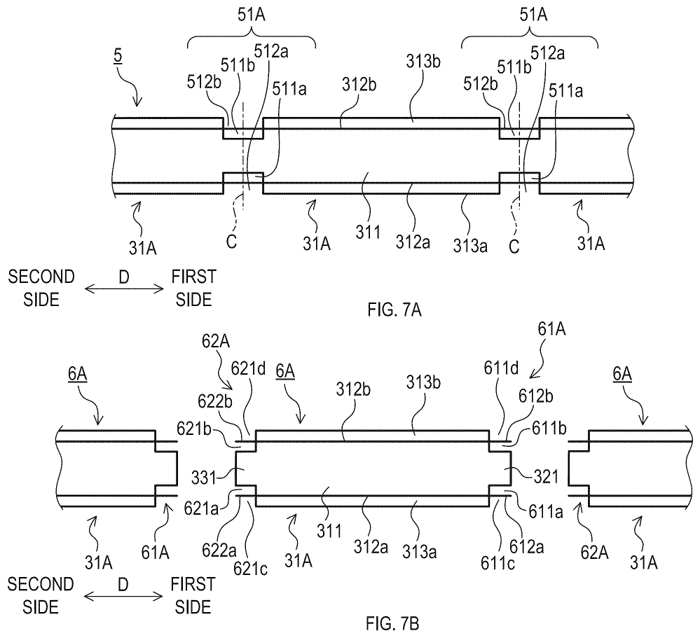

Following the roll forming process, the cutting process is performed. As shown in FIGS. 7A and 7B, during the cutting process, the workpiece 5, which has at least one ridge part (in the first embodiment, ridge parts 314a to 314d) formed during the roll forming process, is cut along a cutting plane C.

The cutting plane C is an imaginary plane passing through the opening group 51A and intersecting the length direction D. When there is only one through part forming the opening group 51A, the cutting plane C passing through the opening group 51A means that the cutting plane C passes through that one through part. When there are multiple through parts forming the opening group 51A, the cutting plane C passing through the opening group 51A means that the cutting plane C passes through all the multiple through parts. The cutting plane C passing through a specific through part can also be said that the cutting plane C has at least one intersection point with an edge of the workpiece 5 forming the specific through part.

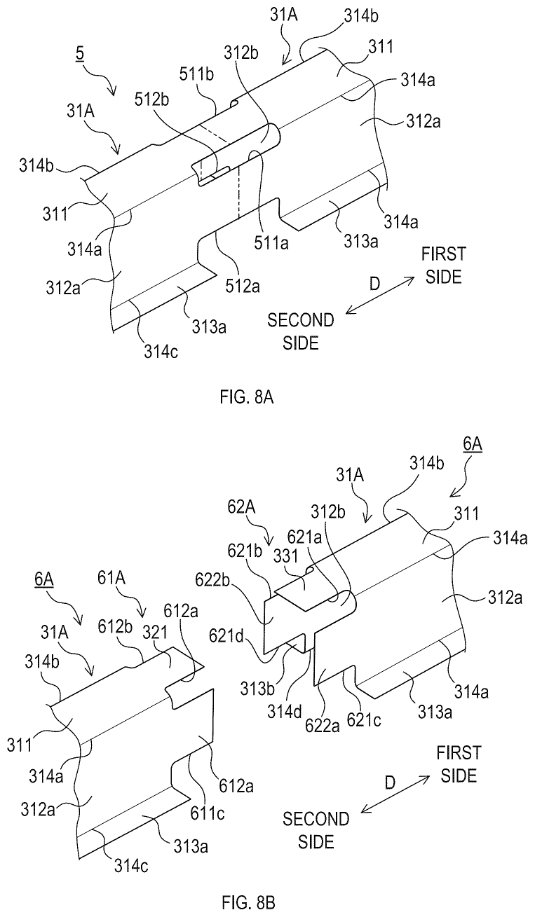

The cutting plane C of the first embodiment passes through all the first through hole 511a, the second through hole 511b, the first notch 512a, and the second notch 512b. More specifically, the cutting plane C of the first embodiment passes through the center of each of the first through hole 511a, the second through hole 511b, the first notch 512a, and the second notch 512b in the length direction D. The cutting plane C is, for example, perpendicular to the length direction D. In FIG. 8A, positions where the cutting plane C intersects the workpiece 5, i.e., positions where the workpiece 5 is cut, are indicated by two-dot chain lines.

As shown in FIGS. 7A and 7B, cutting the workpiece 5 at the cutting plane C passing through each opening group 51A results in a part of the workpiece 5 interposed between the two cutting planes C being obtained as an intermediate formed part 6A. The intermediate formed part 6A has the above-described main body part 31A, a first cutting end part 61A, and a second cutting end part 62A.

The first cutting end part 61A is provided at the first side end of the main body part 31A. Four notches 611a to 611d are formed in the first cutting end part 61A. In the first embodiment, the four notches 611a to 611d are referred to as the first to fourth notches 611a to 611d, respectively, for distinction. The first to fourth notches 611a to 611d are openings corresponding respectively to the first through hole 511a, the second through hole 511b, the first notch 512a, and the second notch 512b before cutting.

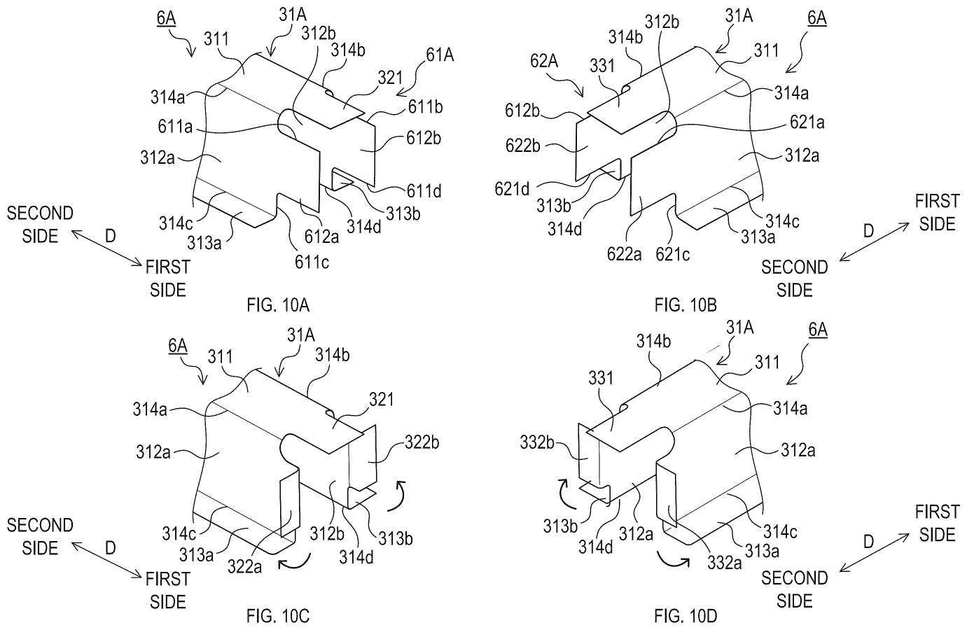

As shown in FIG. 10A, the first cutting end part 61A has three end piece parts 321, 612a, and 612b. In the first embodiment, the three end piece parts 321, 612a, and 612b are referred to as a first end piece part 321, a second end piece part 612a, and a third end piece part 612b, respectively, for distinction.

The first end piece part 321 is a configuration that remains in the finished cross member 3A. As described above, the first end piece part 321 is a flat part extending further toward the first side from the first side edge of the main body wall part 311. The first end piece part 321 is interposed between the first notch 611a and the second notch 611b in the direction perpendicular to the length direction D. In other words, the first end piece part 321 faces the first notch 611a and the second notch 611b from the direction perpendicular to the length direction D.

The second end piece part 612a is a plate-shaped part extending further toward the first side from the first side edge of the first side wall part 312a. The second end piece part 612a is, for example, flat. The second end piece part 612a is interposed between the first notch 611a and the third notch 611c in the direction perpendicular to the length direction D. In other words, the second end piece part 612a faces the first notch 611a and the third notch 611c from the direction perpendicular to the length direction D.

The third end piece part 612b is a plate-shaped part extending further toward the first side from the first side edge of the second side wall part 312b. The third end piece part 612b is, for example, flat. The third end piece part 612b is interposed between the second notch 611b and the fourth notch 611d in the direction perpendicular to the length direction D. In other words, the third end piece part 612b faces the second notch 611b and the fourth notch 611d from the direction perpendicular to the length direction D.

As shown in FIG. 7B, the second cutting end part 62A is provided at the second side end of the main body part 31A. Four notches 621a to 621d are formed in the second cutting end part 62A. In the first embodiment, the four notches 621a to 621d are referred to as the first to fourth notches 621a to 621d, respectively, for distinction. As shown in FIGS. 7A and 7B, the first to fourth notches 621a to 621d correspond to openings respectively corresponding to the first through hole 511a, the second through hole 511b, the first notch 512a, and the second notch 512b before cutting.

As shown in FIG. 8B, the second cutting end part 62A has three end piece parts 331, 622a, and 622b. In the first embodiment, the three end piece parts 331, 622a, and 622b are referred to as the first end piece part 331, the second end piece part 622a, and the third end piece part 622b, respectively, for distinction.

The first end piece part 331 is a configuration that remains in the finished cross member 3A. As described above, the first end piece part 331 is a flat part extending further toward the second side from the second side edge of the main body wall part 311. The first end piece part 331 is interposed between the first notch 621a and the second notch 621b in the direction perpendicular to the length direction D. In other words, the first end piece part 331 faces the first notch 621a and the second notch 621b from the direction perpendicular to the length direction D.

The second end piece part 622a is a flat part extending further toward the second side from the second side edge of the first side wall part 312a. The second end piece part 622a is interposed between the first notch 621a and the third notch 621c in the direction perpendicular to the length direction D. In other words, the second end piece part 622a faces the first notch 621a and the third notch 621c from the direction perpendicular to the length direction D.

The third end piece part 622b is a flat part extending further toward the second side from the second side edge of the second side wall part 312b. The third end piece part 622b is interposed between the second notch 621b and the fourth notch 621d in the direction perpendicular to the length direction D. In other words, the third end piece part 622b faces the second notch 621b and the fourth notch 621d from the direction perpendicular to the length direction D.

### 1-3-4. Bending Process

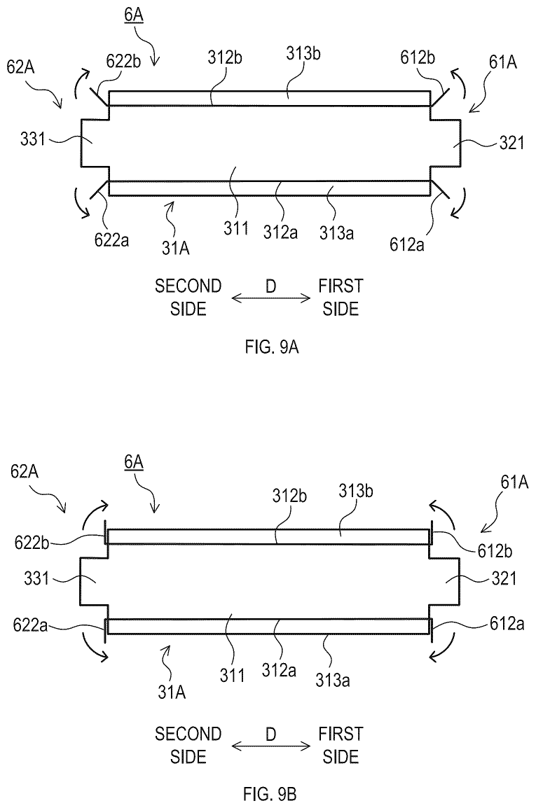

Following the cutting process, the bending process is performed. As shown in FIGS. 9A and 9B, during the bending process, at least one of the end piece parts 321, 331, 612a, 612b, 622a, 622b in the intermediate formed product 6A is bent, forming at least one flange part on the intermediate formed product 6A. At least one of the end piece parts 321, 331, 612a, 612b, 622a, 622b is bent toward the outer side of the main body part 31A.

A method for bending at least one of the end piece parts 321, 331, 612a, 612b, 622a, 622b is not particularly limited. For example, a single-action press machine may be used to bend at least one of these, or a transfer press machine employing a cam mechanism or the like may be used.

As shown FIGS. 10A to 10D, in the first embodiment, the second end piece parts 612a, 622a and the third end piece parts 612b, 622b are bent to form the first end flange parts 322a, 332a and the second end flange parts 322b, 332b on the intermediate formed product 6A. This results in the cross member 3A shown in FIG. 4.

### 1-4. Effects

According to the first embodiment described in detail above, the following effects are achieved.

(1a) The method for manufacturing the cross member 3A comprises the roll forming process, the cutting process, and the bending process. In the roll forming process, the workpiece 5, after the punching process, is bent by roll forming, thereby forming at least one ridge part (in the first embodiment, ridge parts 314a to 314d) on the workpiece 5. The workpiece 5 is then cut along the cut plane C in the cutting process, producing an intermediate formed product 6A. Then, in the subsequent bending process, at least one of the end piece parts 321, 331, 612a, 612b, 622a, 622b (in the first embodiment, the second end piece parts 612a, 622a and the third end piece parts 612b, 622b) is bent to obtain the cross member 3A.

With this configuration, the cross member 3A can be obtained, wherein the first end flange parts 322a, 332a and second end flange parts 322b, 332b are provided at both ends of the main body part 31A in the length direction D. The first end flange parts 322a, 332a and the second end flange parts 322b, 332b enable both ends of the cross member 3A in the length direction D to be fixed to the frame member 2. Consequently, it is possible to obtain the cross member 3A that can fix both ends in the length direction D to the frame member 2 without brackets.

(1b) In the cross member 3A, the dimension in the length direction D of the main body part 31A may need to vary in accordance with the vehicle's overall width. For example, if attempting to produce the cross members 3A with different dimensions in the length direction D of the main body part 31A solely by press forming, separate dies would be required for each dimension.

In contrast, the manufacturing method of the first embodiment further includes a punching process. During the punching process, at least one through part (in the first embodiment, the first through hole 511a, the second through hole 511b, the first notch 512a, and the second notch 512b) is formed in the workpiece 5. With this configuration, the dimension in the length direction D of the main body part 31A can be easily changed by altering the position of the through hole in the length direction D, and consequently, by changing the position where the workpiece 5 is cut during the cutting process. Therefore, it becomes easy to produce cross members 3A with different dimensions in the length direction D.

As in the first embodiment, when the workpiece 5 is fed in a specified direction while being punched by the punching die, it is possible to change the position of the through hole in the length direction D by altering at least one of the feed speed of the workpiece 5 and the interval of the punching die's operation.

(1c) In the roll forming process, the workpiece 5 undergoes roll forming to form the main body part 31A. This configuration allows for a smaller angular error between the first side wall part 312a or the second side wall part 312b and the main body wall part 311 compared to a configuration where the main body part 31A is formed by press forming. This is because, in roll forming, the workpiece 5 is gradually bent by multiple sets of forming rollers 101 to 105 to form the main body part 31A. According to the manufacturing method of the first embodiment, the cross member 3A with even higher precision can be obtained.

(1d) For example, the workpiece 5 is high-tensile steel. In this case, when the main body part 31A is formed by press forming, springback is likely to occur. That is, the angular error between the first side wall part 312a or the second side wall part 312b and the main body wall part 311 tends to become large. Therefore, when the workpiece 5 is high-tensile steel, as in the manufacturing method of the first embodiment, forming the main body part 31A by roll forming to achieve the effect described in (1c) is even more advantageous.

(1e) For example, in a configuration where the main body part 31A is formed by press forming, the angle of the first side wall part 312a or the second side wall part 312b relative to the main body wall part 311 must be greater than 90°because releasing of the die is required after forming. In contrast, when the main body part 31A is formed by roll forming, as in the roll forming process of the first embodiment, releasing of the die is not required. Therefore, the angle of the first side wall part 312a or the second side wall part 312b relative to the main body wall part 311 can be set to any desired angle. For example, this angle can be set to 90°. When this angle is 90°, a proportion of the cross member 3A occupying the space surrounded by the frame member 2 can be reduced when placing the cross member 3A within the frame member 2. Consequently, the area available for placing the battery B can be increased.

### 2. Second Embodiment

### 2-1. Configuration of Cross Member

The second embodiment has a basic configuration similar to that of the first embodiment; therefore, the differences are described below. Note that reference numerals identical to those in the first embodiment indicate identical components, and reference should be made to the preceding description.

A cross member 3B of the second embodiment shown in FIG. 11 comprises a main body part 31B, a first fixed end part 32B, and a second fixed end part 33B.

The main body part 31B includes the above-described main body wall part 311, the side wall part 312a, and the ridge part 314a. A cross section perpendicular to the length direction D in the main body part 31B has a substantially L-shape. In this embodiment, inner and outer sides of the main body part 31B refer to an inner angle side and an outer angle side of the L-shape. The same applies to a third embodiment described later.

The first fixed end part 32B is provided at the first side end of the main body part 31B. The first fixed end part 32B has two end flange parts 322c and 322d. In the second embodiment, the two end flange parts 322c and 322d are referred to as the first end flange part 322c and the second end flange part 322d, respectively, for distinction.

The first end flange part 322c extends from the first side edge of the main body wall part 311 toward the outer side of the main body part 31B. The first end flange part 322c is, for example, flat. The first end flange part 322c intersects the length direction D. The first end flange part 322c is, for example, perpendicular to the length direction D.

The second end flange part 322d has a configuration substantially similar to that of the first end flange part 322a of the first embodiment. However, a ratio of the dimension of the second end flange part 322d along an edge of the side wall part 312a to the dimension of the edge of the side wall part 312a in the second embodiment is greater than a ratio of the dimension of the first end flange part 322a along the edge of the side wall part 312a to the dimension of the edge of the side wall part 312a in the first embodiment. The edge of the side wall part 312a herein is the first side edge of the side wall part 312a.

The second fixed end part 33B is provided at the second side end of the main body part 31B. The second fixed end part 33B has two end flange parts 332c and 332d. In the second embodiment, the two end flange parts 332c and 332d are referred to as the first end flange part 332c and the second end flange part 332d, respectively, for distinction.

The first end flange part 332c extends from the second side edge of the main body wall part 311 toward the outer side of the main body part 31B. The first end flange part 332c is, for example, flat. The first end flange part 332c intersects the length direction D. The first end flange part 332c is, for example, perpendicular to the length direction D.

The second end flange part 332d of the second embodiment has a configuration substantially similar to that of the first end flange part 332a of the first embodiment. However, a ratio of the dimension of the second end flange part 332d along the edge of the side wall part 312a to the dimension of the edge of the side wall part 312a in the second embodiment is greater than a ratio of the dimension of the first end flange part 332a along the edge of the side wall part 312a to the dimension of the edge of the side wall part 312a in the first embodiment. The edge of the side wall part 312a herein is the second side edge of the side wall part 312a.

Similar to the first embodiment, the first fixed end part 32B and the second fixed end part 33B of the cross member 3B are fixed to the frame member 2. Specifically, the first end flange parts 322c, 332c and the second end flange parts 322d, 332d are fixed to the frame member 2.

### 2-2. Method for Manufacturing Cross Member

A method for manufacturing the cross member 3B of the second embodiment also comprises a punching process, a roll forming process, a cutting process, and a bending process, as in the first embodiment.

### 2-2-1. Punching Process

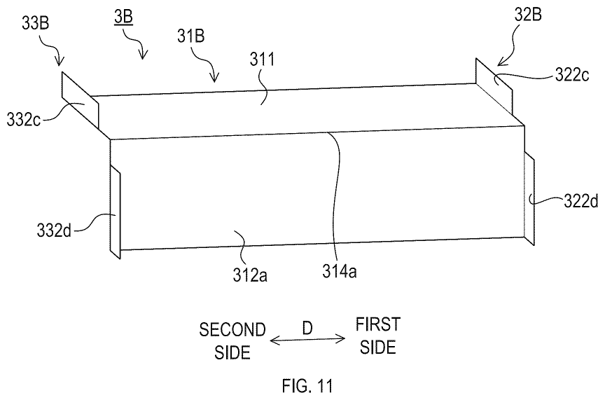

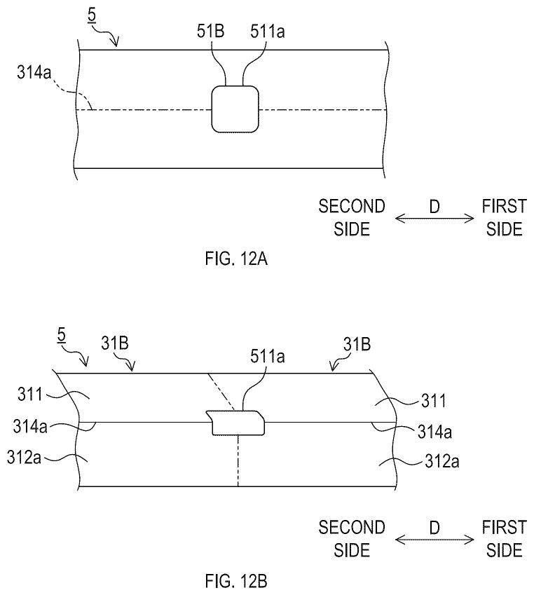

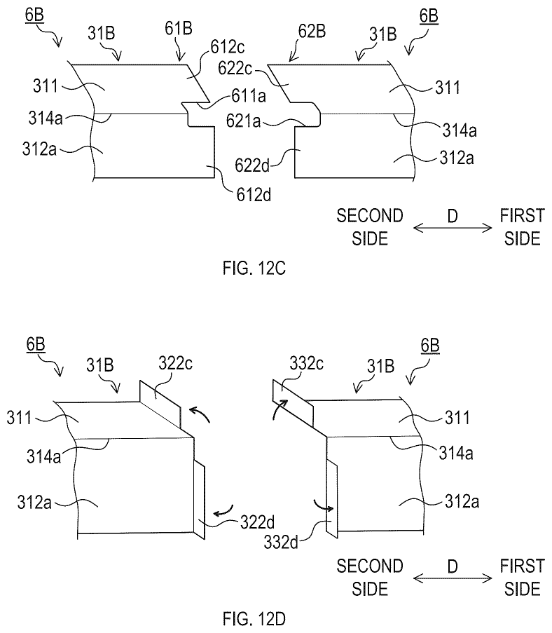

The punching process of the second embodiment has a configuration substantially similar to that of the first embodiment. However, in the punching process of the second embodiment, as shown in FIG. 12A, an opening group 51B has only the above-described through hole 511a as at least one through part. In other words, in the punching process of the second embodiment, only the through hole 511a is formed in the workpiece 5.

FIG. 12A shows the position where the workpiece 5 is bent to form the ridge part 314a during the subsequent roll forming process, indicated by a two-dot chain line.

### 2-2-2. Roll Forming Process

The roll forming process of the second embodiment has a configuration substantially similar to that of the first embodiment. However, in the roll forming process of the second embodiment, as shown in FIG. 12B, only the ridge part 314a is formed on the workpiece 5 after the punching process by roll forming. That is, only the above step (A-1) is performed.

### 2-2-3. Cutting Process

The cutting process of the second embodiment has a configuration substantially similar to that of the first embodiment. However, in the second embodiment, the opening group 51B has only through hole 511a. Therefore, the cutting plane C of the second embodiment is a virtual plane passing only through the through hole 511a and intersecting the length direction D (e.g., perpendicular to the length direction D). Although the cutting plane C of the second embodiment is not shown, FIG. 12B indicates, with a two-dot chain line, the position where the cutting plane C intersects the workpiece 5 after the roll forming process, for reference.

The workpiece 5 is cut at the cutting plane C overlapping each opening group 51B. As a result, the part of the workpiece 5 interposed between the two cutting planes C is obtained as an intermediate formed product 6B shown in FIG. 12C. The intermediate formed product 6B has the above-described main body part 31B, a first cutting end part 61B, and a second cutting end part 62B.

The first cutting end part 61B is provided at the first side end of the main body part 31B. The above-described notch 611a is formed in the first cutting end part 61B. The first cutting end part 61B has two end piece parts 612c and 612d. In the second embodiment, the two end piece parts 612c and 612d are referred to as the first end piece part 612c and the second end piece part 612d, respectively, for distinction.

The first end piece part 612c of the second embodiment has a configuration substantially similar to that of the first end piece part 321 of the first embodiment. However, the first end piece part 612c of the second embodiment faces only the notch 611a.

The second end piece part 612d of the second embodiment has a configuration substantially similar to that of the second end piece part 612a of the first embodiment. However, the second end piece part 612d of the second embodiment faces only the notch 611a.

The second cutting end part 62B is provided at the second side end of the main body part 31B. The second cutting end part 62B has the above-described notch 621a formed therein. The second cutting end part 62B has two end piece parts 622c and 622d. In the second embodiment, the two end piece parts 622c and 622d are referred to as the first end piece part 622c and the second end piece part 622d, respectively, for distinction.

The first end piece part 622c of the second embodiment has a configuration substantially similar to that of the first end piece part 331 of the first embodiment. However, the first end piece part 622c of the second embodiment faces only the notch 621a.

The second end piece part 622d of the second embodiment has a configuration substantially similar to that of the second end piece part 622a of the first embodiment. However, the second end piece part 622d of the second embodiment faces only the notch 621a.

### 2-2-4. Bending Process

The bending process of the second embodiment has a configuration substantially similar to that of the first embodiment. However, as shown in FIGS. 12C and 12D, in the bending process of the second embodiment, the first end piece parts 612c, 622c and the second end piece parts 612d, 622d are bent, forming the first end flange parts 322c, 332c and the second end flange parts 322d, 332d on the intermediate formed product 6B. As a result, the cross member 3B shown in FIG. 11 is obtained.

### 2-3. Effects

With the second embodiment described in detail above, the same effects as those of the first embodiment are obtained.

### 3. Third Embodiment

### 3-1. Configuration of Cross Member

The third embodiment has a basic configuration similar to that of the second embodiment; therefore, the differences are described below. Note that the same reference numerals as in the first and second embodiments indicate identical configurations, and reference should be made to the preceding descriptions.

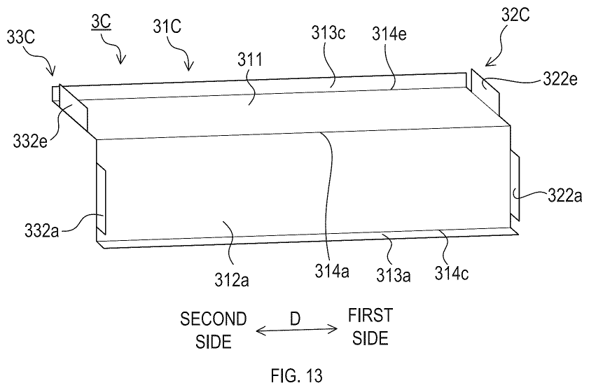

As shown in FIG. 13, a cross member 3C of the third embodiment comprises a main body part 31C, a first fixed end part 32C, and a second fixed end part 33C.

The main body part 31C comprises the main body wall part 311, the side wall part 312a, and the ridge part 314a, as well as two main body flange parts 313a and 313c and two ridge parts 314c and 314e. In the third embodiment, the two main body flange parts 313a and 313c are referred to as the first main body flange part 313a and the second main body flange part 313c, respectively, for distinction. The first main body flange part 313a is as detailed in the first embodiment. In the third embodiment, the three ridge parts 314a, 314c, and 314e are referred to as the first to third ridge parts 314a, 314c, and 314e, respectively, for distinction. The first ridge part 314a and the second ridge part 314c are as described in detail in the first embodiment as the first ridge part 314a and the third ridge part 314c.

The second main body flange part 313c is a plate-shaped part extending in the length direction D. The second main body flange part 313c is, for example, flat. The second main body flange part 313c is continuous with the edge of the main body wall part 311 opposite to the side wall part 312a via the third ridge part 314e. The second main body flange part 313c is disposed on the outer side of the main body part 31C relative to the main body wall part 311. In other words, the second main body flange part 313c is disposed on the opposite side of the side wall part 312a across the main body wall part 311. The second main body flange part 313c forms an angle with the main body wall part 311. The angle formed between the main body wall part 311 and the second main body flange part 313c is, for example, 90°.

The third ridge part 314e is a plate-shaped part extending in the length direction D. A cross section perpendicular to the length direction D of the third ridge part 314e is curved in an arc shape, bulging toward the inner side of the main body part 31C. The third ridge part 314e couples the main body wall part 311 and the second main body flange part 313c to form a ridge line therebetween.

The first fixed end part 32C is provided at the first side end of the main body part 31C. The first fixed end part 32C has two end flange parts 322e and 322a. In the third embodiment, the two end flange parts 322e and 322a are referred to as the first end flange part 322e and the second end flange part 322a, respectively, for distinction. The first end flange part 322e extends from the first side edge of the main body wall part 311 toward the outer side of the main body part 31C. The first end flange part 322e is plate-shaped (e.g., flat). The first end flange part 322e intersects the length direction D. The first end flange part 322e is, for example, perpendicular to the length direction D. The second end flange part 322a is as described in detail as the first end flange part 322a in the first embodiment.

The second fixed end part 33C is provided at the second side end of the main body part 31C. The second fixed end part 33C has two end flange parts 332e and 332a. In the third embodiment, the two end flange parts 332e and 332a are referred to as the first end flange part 332e and the second end flange part 332a, respectively, for distinction. The first end flange part 332e extends from the second side edge of the main body wall part 311 toward the outer side of the main body part 31C. The first end flange part 332e is plate-shaped (e.g., flat). The first end flange part 332e intersects the length direction D. The first end flange part 332e is, for example, perpendicular to the length direction D. The second end flange part 332a is as detailed in the first embodiment as the first end flange part 332a.

Similar to the second embodiment, the first fixed end part 32C and the second fixed end part 33C of the cross member 3C are fixed to the frame member 2. Specifically, the first end flange parts 322e, 332e and the second end flange parts 322a, 332a are fixed to the frame member 2.

### 3-2. Method for Manufacturing Cross Member

The method for manufacturing the cross member 3C in the third embodiment also includes a punching process, a roll forming process, a cutting process, and a bending process, as in the second embodiment.

### 3-2-1. Punching Process

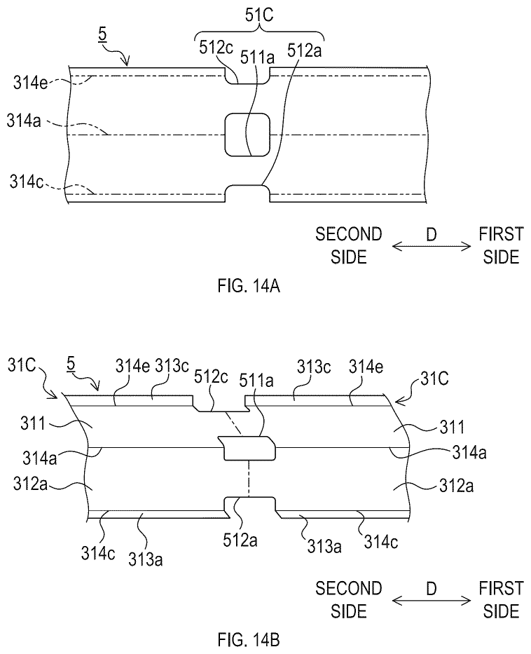

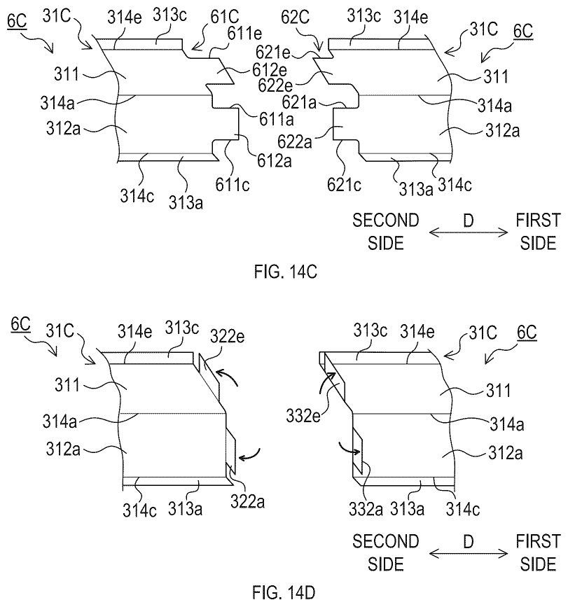

The punching process of the third embodiment has a configuration substantially similar to that of the second embodiment. However, in the punching process of the third embodiment, as shown in FIG. 14A, an opening group 51C includes at least one through part having a through hole 511a and two notches 512a, 512c. In other words, in the punching process of the third embodiment, the through hole 511a and two notches 512a, 512c are formed in the workpiece 5. In the third embodiment, the two notches 512a, 512c are referred to as the first notch 512a and the second notch 512c, respectively, for distinction. The through hole 511a, the first notch 512a, and the second notch 512c are arranged in the order of the first notch 512a, the through hole 511a, and the second notch 512c in the direction intersecting the length direction D (e.g., the direction perpendicular to the length direction D).

FIG. 14A shows, with two-dot chain lines, the positions where the workpiece 5 is bent in the subsequent roll forming process to form the first to third ridge parts 314a, 314c, and 314e.

### 3-2-2. Roll Forming Process

The roll forming process of the third embodiment has a configuration substantially similar to that of the second embodiment. However, in the roll forming process of the third embodiment, as shown in FIG. 14B, the first to third ridge parts 314a, 314c, and 314e are formed on the workpiece 5 by roll forming.

More specifically, the workpiece 5 is bent by roll forming as described in steps (A-1) and (A-3) above and in step (C-1) below. The steps described in steps (A-1) and (A-3) above and in step (C-1) below may be performed sequentially one by one, or at least two of them may be performed in parallel.

(C-1) The workpiece 5 is bent such that a part corresponding to the second main body flange part 313c forms an angle with a part corresponding to the main body wall part 311. At this time, the workpiece 5 is bent such that the part corresponding to the second main body flange part 313c does not face a part corresponding to the side wall part 312a. By bending the workpiece 5 as described in step (C-1), the third ridge part 314e is formed on the workpiece 5. The third ridge part 314e is formed to overlap with the second notch 512c. The third ridge part 314e extends along the length direction D.

A part of the workpiece 5 that is continuous with the main body wall part 311 via the third ridge part 314e corresponds to the second main body flange part 313c.

### 3-2-3. Cutting Process

The cutting process of the third embodiment has a configuration substantially similar to that of the second embodiment. However, in the third embodiment, the opening group 51C has a through hole 511a, a first notch 512a, and a second notch 512c. Therefore, the cutting plane C in the third embodiment is a virtual plane passing through the through hole 511a, the first notch 512a, and the second notch 512c, and intersecting the length direction D (e.g., perpendicular to the length direction D). Although the cutting plane C of the third embodiment is not shown, FIG. 14B indicates, with a two-dot chain line, the position where the cutting plane C intersects the workpiece 5 after the roll forming process, for reference.

The workpiece 5 is cut at the cutting plane C overlapping each opening group 51C. As a result, a part of the workpiece 5 interposed between the two cutting planes C is obtained as an intermediate formed product 6C shown in FIG. 14C. The intermediate formed product 6C has the above-described main body part 31C, a first cutting end part 61C, and a second cutting end part 62C.

The first cutting end part 61C is provided at the first side end of the main body part 31C. Three notches 611a, 611c, and 611e are formed in the first cutting end part 61C. In the third embodiment, the three notches 611a, 611c, and 611e are referred to as the first to third notches 611a, 611c, and 611e, respectively, for distinction. The first notch 611a and the second notch 611c are as described in detail for the first notch 611a and the third notch 611c in the first embodiment. The third notch 611e is an opening corresponding to the second notch 512c before cutting.

The first cutting end part 61C has two end piece parts 612e and 612a. In the third embodiment, the two end piece parts 612e and 612a are referred to as the first end piece part 612e and the second end piece part 612a, respectively, for distinction. The first end piece part 612e of the third embodiment has a configuration substantially similar to that of the first end piece part 321 of the first embodiment. The first end piece part 612e of the third embodiment faces the first notch 611a and the third notch 611e from the direction perpendicular to the length direction D. The second end piece part 612a is as described in detail in the first embodiment.

The second cutting end part 62C is provided at the second side end of the main body part 31C. Three notches 621a, 621c, and 621e are formed in the second cutting end part 62C. In the third embodiment, the three notches 621a, 621c, and 621e are referred to as the first to third notches 621a, 621c, and 621e, respectively, for distinction. The first notch 621a and the second notch 621c are as detailed in the first embodiment for the first notch 621a and the third notch 621c. The third notch 621e is an opening corresponding to the second notch 512c before cutting.

The second cutting end part 62C has two end piece parts 622e and 622a. In the third embodiment, the two end piece parts 622e and 622a are referred to as the first end piece part 622e and the second end piece part 622a, respectively, for distinction. The first end piece part 622e of the third embodiment has a configuration substantially similar to that of the first end piece part 331 of the first embodiment. The first end piece part 622e of the third embodiment faces the first notch 621a and the third notch 621e from the direction perpendicular to the length direction D. The second end piece part 622a is as described in detail in the first embodiment.

### 3-2-4. Bending Process

As shown in FIGS. 14C and 14D, in the bending process of the third embodiment, the first end piece parts 612e, 622e and the second end piece parts 612a, 622a are bent, as in the second embodiment. This forms the first end flange parts 322e, 332e and the second end flange parts 322a, 332a on the intermediate formed product 6C. As a result, the cross member 3C shown in FIG. 13 is obtained.

### 3-3. Effects

According to the third embodiment described in detail above, effects similar to those of the second embodiment are obtained.

### 4. Fourth Embodiment

### 4-1. Configuration of Cross Member

The fourth embodiment has a basic configuration similar to that of the first embodiment. Therefore, the differences are described below. Note that the same reference numerals as in the first to third embodiments indicate identical configurations, and reference should be made to the preceding descriptions.

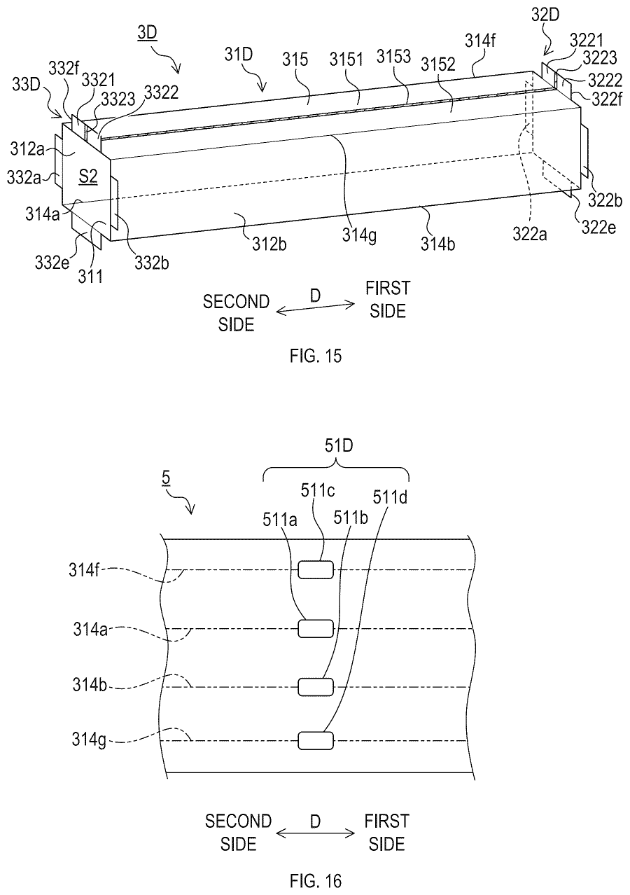

As shown in FIG. 15, a cross member 3D of the fourth embodiment includes a main body part 31D, a first fixed end part 32D, and a second fixed end part 33D.

The main body part 31D is a substantially rectangular tubular part. Hereinafter, a space surrounded on all four sides by the main body part 31D is referred to as an internal space S2. Inner and outer sides of the main body part 31D refer to a side facing the internal space S2 relative to the main body part 31D and a side opposite thereto, respectively.

The main body part 31D includes the main body wall part 311, the first side wall part 312a, the second side wall part 312b, an opposing wall part 315, and four ridge parts 314a, 314b, 314f, and 314g. In the fourth embodiment, the four ridge parts 314a, 314b, 314f, and 314g are referred to as the first to fourth ridge parts 314 a, 314 b, 314f, and 314g, respectively, for distinction. The main body wall part 311, the first side wall part 312a, the second side wall part 312b, the first ridge part 314a, and the second ridge part 314b are as described in detail in the first embodiment.

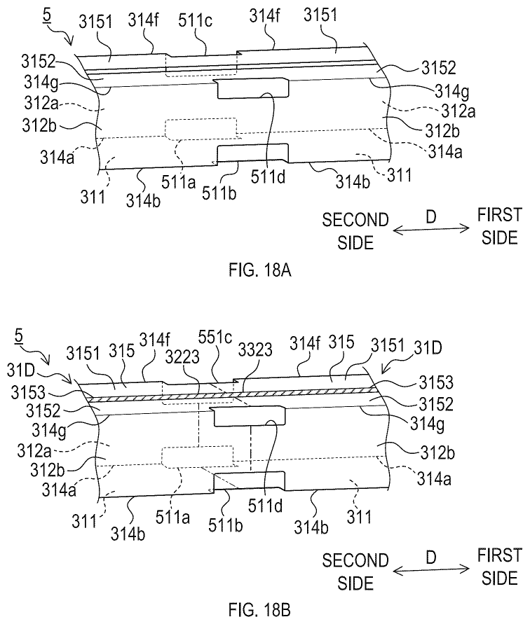

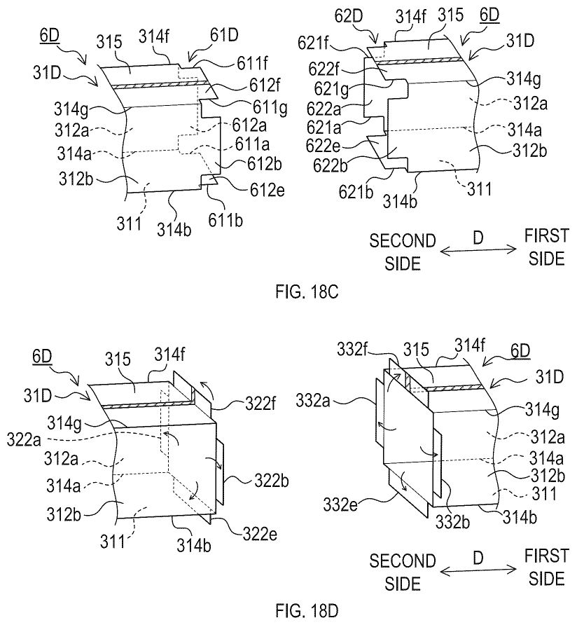

FIG. 15 and 18A to 18D show the cross member 3D or the workpiece 5 oriented with the main body wall part 311 side facing downward and the opposing wall part 315 side facing upward. Therefore, the first side wall part 312a is located at the rear side of the drawing, and the second side wall part 312b is located at the front side of the drawing.

As shown in FIG. 15, the opposing wall part 315 is a plate-shaped part extending in the length direction D. The opposing wall part 315 is, for example, flat. The opposing wall part 315 faces the main body wall part 311 at a distance. The opposing wall part 315 is parallel to the main body wall part 311. The opposing wall part 315 is continuous with the edge of the first side wall part 312a opposite to the main body wall part 311 via the third ridge part 314f. The opposing wall part 315 is coupled to the edge of the second side wall part 312b opposite to the main body wall part 311 via the fourth ridge part 314g.

The opposing wall part 315 comprises a first plate-shaped part 3151, a second plate-shaped part 3152, and a welded part 3153. The first plate-shaped part 3151 and the second plate-shaped part 3152 are plate-shaped (e.g., flat) parts. The first plate-shaped part 3151 and the second plate-shaped part 3152 are adjacent to each other in the direction perpendicular to the length direction D. The welded part 3153 is a part where opposing end faces of the first plate-shaped part 3151 and the second plate-shaped part 3152 are welded together.

The third ridge part 314f and the fourth ridge part 314g are plate-shaped parts extending in the length direction D. Cross sections of the third ridge part 314f and the fourth ridge part 314g perpendicular to the length direction D are curved in an arc shape toward the outer side of the main body part 31D. The third ridge part 314f couples the first side wall part 312a and the opposing wall part 315 (specifically, the first plate-shaped part 3151) to form a ridge line therebetween. The fourth ridge part 314g couples the second side wall part 312b and the opposing wall part 315 (specifically, the second plate-shaped part 3152) to form a ridge line therebetween.

The first fixed end part 32D is provided at the first side end of the main body part 31D. The first fixed end part 32D has four end flange parts 322e, 322a, 322b, and 322f. In the fourth embodiment, the four end flange parts 322e, 322a, 322b, and 322f are referred to as the first to fourth end flange parts 322e, 322a, 322b, and 322f, respectively, for distinction. The first end flange part 322e is as described in detail in the third embodiment. The second end flange part 322a and the third end flange part 322b are as described in detail in the first embodiment as the first end flange part 322a and the second end flange part 322b.

The fourth end flange part 322f extends from the first side edge of the opposing wall part 315 toward the outer side of the main body part 31D. The fourth end flange part 322f is plate-shaped (e.g., flat). The fourth end flange part 322f intersects the length direction D. The fourth end flange part 322f is, for example, perpendicular to the length direction D.

The fourth end flange part 322f includes a first plate-shaped part 3221, a second plate-shaped part 3222, and a welded part 3223. The first plate-shaped part 3221, the second plate-shaped part 3222, and the welded part 3223 in the fourth end flange part 322f are respectively continuous with the first plate-shaped part 3151, the second plate-shaped part 3152, and the welded part 3153 in the opposing wall part 315. The first plate-shaped part 3221 and the second plate-shaped part 3222 are plate-shaped (e.g., flat). The first plate-shaped part 3221 and the second plate-shaped part 3222 are adjacent to each other in the direction perpendicular to the length direction D. The welded part 3223 is a part where opposing end faces of the first plate-shaped part 3221 and the second plate-shaped part 3222 are welded together.

The second fixed end part 33D is provided at the second side end of the main body part 31D. The second fixed end part 33D has four end flange parts 332e, 332a, 332b, and 332f. In the fourth embodiment, the four end flange parts 332e, 332a, 332b, and 332f are referred to as the first to fourth end flange parts 332e, 332a, 332b, and 332f, respectively, for distinction. The first end flange part 332e is as described in detail in the third embodiment. The second end flange part 332a and the third end flange part 332b are as described in detail in the first embodiment as the first end flange part 332a and the second end flange part 332b.

The fourth end flange part 332f extends from the second side edge of the opposing wall part 315 toward the outer side of the main body part 31D. The fourth end flange part 332f is plate-shaped (e.g., flat). The fourth end flange part 332f intersects the length direction D. The fourth end flange part 332f is, for example, perpendicular to the length direction D.

The fourth end flange part 332f includes a first plate-shaped part 3321, a second plate-shaped part 3322, and a welded part 3323. The first plate-shaped part 3321, the second plate-shaped part 3322, and the welded part 3323 in the fourth end flange part 332f are respectively continuous with the first plate-shaped part 3151, the second plate-shaped part 3152, and the welded part 3153 in the opposing wall part 315. The first plate-shaped part 3321 and the second plate-shaped part 3322 are plate-shaped (e.g., flat). The first plate-shaped part 3321 and the second plate-shaped part 3322 are adjacent to each other in the direction perpendicular to the length direction D. The welded part 3323 is a part where opposing end faces of the first plate-shaped part 3321 and the second plate-shaped part 3322 are welded together.

Similar to the first embodiment, the first fixed end part 32D and the second fixed end part 33D of the cross member 3D are fixed to the frame member 2. Specifically, the first end flange parts 322e, 332e, the second end flange parts 322a, 332a, the third end flange parts 322b, 332b, and the fourth end flange parts 322f, 332f are fixed to the frame member 2.

### 4-2. Method for Manufacturing Cross Member

The method for manufacturing the cross member 3D of the fourth embodiment further includes a welding process in addition to the punching process, the roll forming process, the cutting process, and the bending process. The welding process is performed between the roll forming process and the cutting process.

### 4-2-1. Punching Process

The punching process of the fourth embodiment has a configuration substantially similar to that of the punching process of the first embodiment. However, in the punching process of the fourth embodiment, as shown in FIG. 16, an opening group 51D has four through holes 511a to 511d as at least one through part. In other words, in the punching process of the fourth embodiment, four through holes 511a to 511d are formed in the workpiece 5. In the fourth embodiment, the four through holes 511a to 511d are referred to as the first to fourth through holes 511a to 511d, respectively, for distinction. The first to fourth through holes 511a to 511d are arranged in the direction intersecting the length direction D (e.g., perpendicular to the length direction D) in the order of the third through hole 511c, the first through hole 511a, the second through hole 511b, and the fourth through hole 511d.

FIG. 16 shows, with two-dot chain lines, positions where the workpiece 5 is bent during the subsequent roll forming process to form the first to fourth ridge parts 314a, 314b, 314f, and 314g.

### 4-2-2. Roll Forming Process

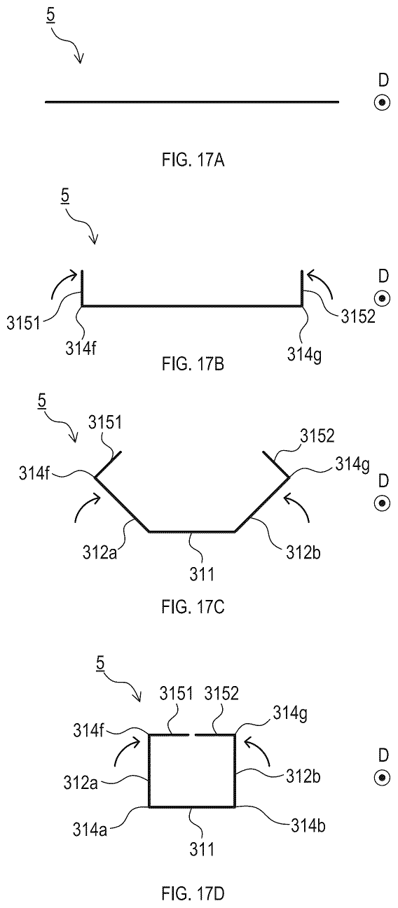

The roll forming process of the fourth embodiment has a configuration substantially similar to that of the roll forming process of the first embodiment. However, in the roll forming process of the fourth embodiment, as shown in FIGS. 17A to 17D, the first to fourth ridge parts 314a, 314b, 314f, and 314g are formed on the workpiece 5 by roll forming.

More specifically, the workpiece 5 is bent by roll forming as described in steps (A-1) and (A-2) above and in steps (D-1) and (D-2) below.

(D-1) As shown in FIG. 17B, the workpiece 5 is bent such that a part corresponding to the first plate-shaped part 3151 forms an angle with a part corresponding to the first side wall part 312a. This forms the third ridge part 314f on the workpiece 5. As shown in FIG. 18A, the third ridge part 314f is formed to overlap the third through hole 511c. The third ridge part 314f extends along the length direction D.

(D-2) As shown in FIG. 17B, the workpiece 5 is bent such that a part corresponding to the second plate-shaped part 3152 forms an angle with a part corresponding to the second side wall part 312b. This forms the fourth ridge part 314g on the workpiece 5. As shown in FIG. 18A, the fourth ridge part 314g is formed to overlap the fourth through hole 511d. The fourth ridge part 314g extends along the length direction D.

The above steps (A-1), (A-2), (D-1), and (D-2) may be performed individually, or at least two of them may be performed in parallel. In the fourth embodiment, as shown in FIGS. 17A to 17D, the above steps (D-1) and (D-2) are performed in parallel first, followed by the above steps (A-1) and (A-2) performed in parallel. In this case, bending of the workpiece 5 such that the part corresponding to the first plate-shaped part 3151 in step (D-1) forms an angle with the part corresponding to the first side wall part 312a can also be said to bending the workpiece 5 such that the part corresponding to the first plate-shaped part 3151 faces the part corresponding to the second plate-shaped part 3152.

As shown in FIG. 17D, the part of the workpiece 5 interposed between the first ridge part 314a and the second ridge part 314b corresponds to the main body wall part 311. The part of the workpiece 5 interposed between the first ridge part 314a and the third ridge part 314f corresponds to the first side wall part 312a. The part of the workpiece 5 interposed between the second ridge part 314b and the fourth ridge part 314g corresponds to the second side wall part 312b. The part of the workpiece 5 continuous with the first side wall part 312a via the third ridge part 314f corresponds to the first plate-shaped part 3151. The part of the workpiece 5 continuous with the second side wall part 312b via the fourth ridge part 314g corresponds to the second plate-shaped part 3152.

As shown in FIG. 18A, two end faces of the workpiece 5 after the roll forming process face each other in the direction perpendicular to the length direction D. These two end faces include the end face of the first plate-shaped part 3151 and the end face of the second plate-shaped part 3152.

### 4-2-3. Welding Process

Following the roll forming process, the welding process is performed. As shown in FIGS. 18A and 18B, during the welding process, the opposing end faces of the workpiece 5 after the roll forming process are welded together. This forms welded parts 3153, 3223, and 3323 in the workpiece 5. The first plate-shaped part 3151 and the second plate-shaped part 3152 are coupled by the welded part 3153, thereby forming the opposing wall part 315 in the workpiece 5.

### 4-2-4. Cutting Process

Following the welding process, the cutting process is performed. The cutting process of the fourth embodiment has a configuration substantially similar to that of the first embodiment. However, in the fourth embodiment, the opening group 51D has first to fourth through holes 511a to 511d. Therefore, the cutting plane C of the fourth embodiment is a virtual plane passing through the first to fourth through holes 511a to 511d and intersecting the length direction D (e.g., perpendicular to the length direction D). Although the cutting plane C of the fourth embodiment is not shown, FIG. 18B indicates, with a two-dot chain line, the position where the cutting plane C intersects the workpiece 5 after the welding process, for reference.

The workpiece 5 is cut at the cutting plane C, which overlaps with each opening group 51D. As a result, a part of the workpiece 5 interposed between the two cutting planes C is obtained as an intermediate formed part 6D shown in FIG. 18C. The intermediate formed part 6D has the above-described main body part 31D, a first cutting end part 61D, and a second cutting end part 62D.

The first cutting end part 61D is provided at the first side end of the main body part 31D. Four notches 611a, 611b, 611f, and 611g are formed in the first cutting end part 61D. In the fourth embodiment, the four notches 611a, 611b, 611f, and 611g are referred to as the first to fourth notches 611a, 611b, 611f, and 611g, respectively, for distinction. The first notch 611a and second notch 611b are as detailed in the first embodiment. The third notch 611f is an opening corresponding to the third through hole 511c before cutting. The fourth notch 611g is an opening corresponding to the fourth through hole 511d before cutting.

The first cutting end part 61D has four end piece parts 612e, 612a, 612b, and 612f. In the fourth embodiment, the four end piece parts 612e, 612a, 612b, and 612f are referred to as the first to fourth end piece parts 612e, 612a, 612b, and 612f, respectively, for distinction. The first to third end piece parts 612e, 612a, and 612b are as detailed in the first or third embodiment. However, the second end piece part 612a of the fourth embodiment faces the first notch 611a and the third notch 611f from the direction perpendicular to the length direction D. The third end piece part 612b of the fourth embodiment faces the second notch 611b and the fourth notch 611g from the direction perpendicular to the length direction D.

The fourth end piece part 612f extends further toward the first side from the first side edge of the opposing wall part 315. The fourth end piece part 612f is plate-shaped (e.g., flat). The fourth end piece part 612f faces the third notch 611f and the fourth notch 611g from the direction perpendicular to the length direction D.

The second cutting end part 62D is provided at the second side end of the main body part 31D. Four notches 621a, 621b, 621f, and 621g are formed in the second cutting end part 62D. In the fourth embodiment, the four notches 621a, 621b, 621f, and 621g are referred to as the first to fourth notches 621a, 621b, 621f, and 621g, respectively, for distinction. The first notch 621a and second notch 621b are as detailed in the first embodiment. The third notch 621f is an opening corresponding to the third through hole 511c before cutting. The fourth notch 621g is an opening corresponding to the fourth through hole 511d before cutting.

The second cutting end part 62D has four end piece parts 622e, 622a, 622b, and 622f. In the fourth embodiment, the four end piece parts 622e, 622a, 622b, and 622f are referred to as the first to fourth end piece parts 622e, 622a, 622b, and 622f, respectively, for distinction. The first to third end piece parts 622e, 622a, and 622b are as detailed in the first or third embodiment. However, the second end piece part 622a of the fourth embodiment faces the first notch 621a and the third notch 621f from the direction perpendicular to the length direction D. The third end piece part 622b of the fourth embodiment faces the second notch 621b and the fourth notch 621f from the direction perpendicular to the length direction D.

The fourth end piece part 622f extends further toward the second side from the second side edge of the opposing wall part 315. The fourth end piece part 622f is plate-shaped (e.g., flat). The fourth end piece part 622f faces the third notch 621f and the fourth notch 621g from the direction perpendicular to the length direction D.

### 4-2-5. Bending Process

The cutting process of the fourth embodiment has a configuration substantially similar to that of the first embodiment. However, in the bending process of the fourth embodiment, as shown in FIGS. 18C and 18D, the first end piece parts 612e, 622e, the second end piece parts 612a, 622a, the third end piece parts 612b, 622b, and the fourth end piece parts 612f, 622f are bent. This forms the first end flange parts 322e, 332e, the second end flange parts 322a, 332a, the third end flange parts 322b, 332b, and the fourth end flange parts 322f, 332f on the intermediate formed product 6D. As a result, the cross member 3D shown in FIG. 15 is obtained.

### 4-3. Effects

According to the fourth embodiment described in detail above, the same effects as those of the first embodiment are obtained.

### 5. Fifth Embodiment

### 5-1. Configuration of Cross Member

The fifth embodiment has a basic configuration similar to that of the fourth embodiment; therefore, the differences are described below. Note that the same reference numerals as in the first to fourth embodiments indicate identical configurations, and reference should be made to the preceding description.

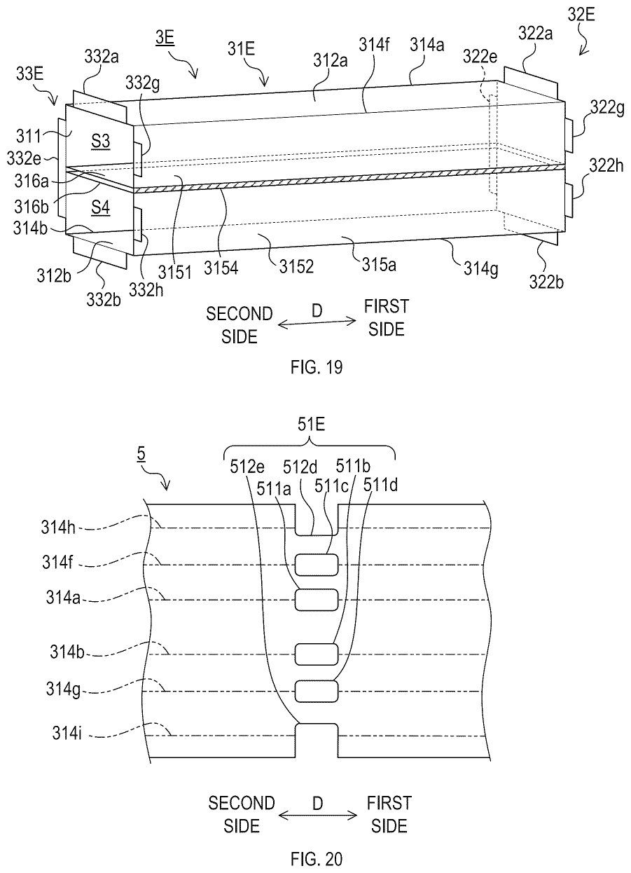

As shown in FIG. 19, a cross member 3E of the fifth embodiment comprises a main body part 31E, a first fixed end part 32E, and a second fixed end part 33E.

The main body part 31E of the fifth embodiment has a configuration substantially similar to that of the main body part 31D of the fourth embodiment. However, the main body part 31E of the fifth embodiment has an opposing wall part 315a instead of the opposing wall part 315. Furthermore, the main body part 31E of the fifth embodiment additionally has two central wall parts 316a and 316b. In the fifth embodiment, these two central wall parts 316a and 316b are referred to as the first central wall part 316a and the second central wall part 316b, respectively, for distinction.

The opposing wall part 315a of the fifth embodiment differs from the opposing wall part 315 of the fourth embodiment in that opposing wall part 315a has a welded part 3154 instead of the welded part 3153. The welded part 3154 will be described later.

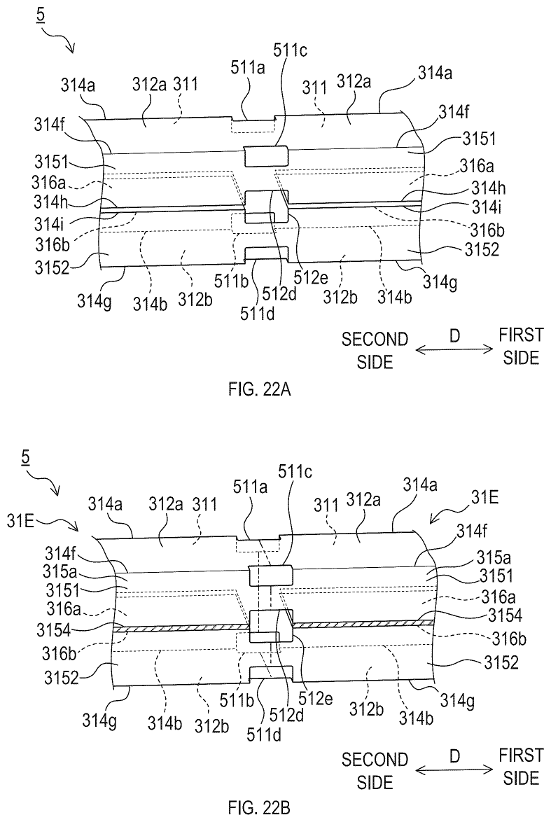

As shown in FIG. 22A, the first central wall part 316a is a plate-shaped part formed from an edge of the first plate-shaped part 3151 opposite to the first side wall part 312a by bending. A part forming a ridge line between the first plate-shaped part 3151 and the first central wall part 316a is referred to as a fifth ridge part 314h. The fifth ridge part 314h is a configuration visible during the manufacturing process of the cross member 3E and does not remain on the finished cross member 3E.

The second central wall part 316b is a plate-shaped part formed from an edge of the second plate-shaped part 3152 opposite to the second side wall part 312b by bending. A part forming a ridge line between the second plate-shaped part 3152 and the second central wall part 316b is referred to as a sixth ridge part 314i. The sixth ridge part 314i is a configuration visible during the manufacturing process of the cross member 3E and does not remain on the finished cross member 3E.

As shown in FIG. 19, the first central wall part 316a and the second central wall part 316b are plate-shaped (e.g., flat). The first central wall part 316a and the second central wall part 316b extend in the length direction D. The first central wall part 316a and the second central wall part 316b are disposed between the main body wall part 311 and the opposing wall part 315a, facing the first side wall part 312a or the second side wall part 312b. The first central wall part 316a faces the first side wall part 312a at a distance. The second central wall part 316b faces the second side wall part 312b at a distance. The first central wall part 316a and the second central wall part 316b are substantially parallel to the first side wall part 312a and the second side wall part 312b.

In FIGS. 19, 21F, 22A, 22B, 23A and 23B, a gap is shown between the first central wall part 316a and the second central wall part 316b for illustrative purposes. However, this gap may or may not be provided. When this gap is not provided, the first central wall part 316a and the second central wall part 316b are in contact with each other.

As shown in FIGS. 22A and 22B, the welded part 3154 is a part where the fifth ridge part 314h and the sixth ridge part 314i are integrally joined by welding. That is, in the finished cross member 3E, the fifth ridge part 314h and the sixth ridge part 314i are visually perceived as being integrated as the welded part 3154. As shown in FIG. 19, an end face of the first central wall part 316a opposite to the welded part 3154 is in contact with the main body wall part 311. An end face of the second central wall part 316b opposite to the welded part 3154 is in contact with the main body wall part 311.

A cross section of the main body part 31E in the direction perpendicular to the length direction D is substantially B-shaped. Specifically, a part of the main body wall part 311, the first side wall part 312a, the first plate-shaped part 3151, and the first central wall part 316a, together with the first ridge part 314a, the third ridge part 314f, and the welded part 3154, form a substantially rectangular tubular part. Hereinafter, a space surrounded on all four sides by the main body wall part 311, the first side wall part 312a, the first plate-shaped part 3151, and the first central wall part 316a is referred to as an internal space S3. The remaining part of the main body wall part 311, the second side wall part 312b, the second plate-shaped part 3152, and the second central wall part 316b, together with the second ridge part 314b, the fourth ridge part 314g, and the welded part 3154, form a substantially rectangular tubular part. Hereinafter, a space surrounded on all sides by the main body wall part 311, the second side wall part 312b, the second plate-shaped part 3152, and the second central wall part 316b is referred to as an internal space S4. An inner side of the main body part 31E refers to a side facing the internal spaces S3 and S4 relative to the main body wall part 311, the first side wall part 312a, the second side wall part 312b, and the opposing wall part 315a. An outer side of the main body part 31E refers to a side opposite to the side facing the internal spaces S3 and S4 relative to the main body wall part 311, the first side wall part 312a, the second side wall part 312b, and the opposing wall part 315a.

The first fixed end part 32E is provided at the first side end of the main body part 31E. The first fixed end part 32E has five end flange parts 322e, 322a, 322b, 322g, and 322h. In the fifth embodiment, the five end flange parts 322e, 322a, 322b, 322g, and 322h are referred to as the first to fifth end flange parts 322e, 322a, 322b, 322g, and 322h, respectively, for distinction. The first end flange part 322e is as described in detail in the third embodiment. The second end flange part 322a and the third end flange part 322b are as described in detail in the first embodiment as the first end flange part 322a and the second end flange part 322b.

The fourth end flange part 322g and the fifth end flange part 322h are plate-shaped (e.g., flat) parts. The fourth end flange part 322g extends from the first side edge of the first plate-shaped part 3151 toward the outer side of the main body part 31E. The fifth end flange part 322h extends from the first side edge of the second plate-shaped part 3152 toward the outer side of the main body part 31E. The fourth end flange part 322g and the fifth end flange part 322h intersect the length direction D. The fourth end flange part 322g and the fifth end flange part 322h are, for example, perpendicular to the length direction D.

The second fixed end part 33E is provided at the second end of the main body part 31E. The second fixed end part 33E has five end flange parts 332e, 332a, 332b, 332g, and 332h. In the fifth embodiment, the five end flange parts 332e, 332a, 332b, 332g, and 332h are referred to as the first to fifth end flange parts 332e, 332a, 332b, 332g, and 332h, respectively, for distinction. The first end flange part 332e is as detailed in the third embodiment. The second end flange part 332a and the third end flange part 332b are as detailed in the first embodiment as the first end flange part 332a and the second end flange part 332b.

The fourth end flange part 332g and the fifth end flange part 332h are plate-shaped (e.g., flat) parts. The fourth end flange part 332g extends from the second side edge of the first plate-shaped part 3151 toward the outer side of the main body part 31E. The fifth end flange part 332h extends from the second side edge of the second plate-shaped part 3152 toward the outer side of the main body part 31E. The fourth end flange part 332g and the fifth end flange part 332h intersect the length direction D. The fourth end flange part 332g and the fifth end flange part 332h are, for example, perpendicular to the length direction D.

Similar to the fourth embodiment, the first fixed end part 32E and the second fixed end part 33E of the cross member 3E are fixed to the frame member 2. Specifically, the first end flange parts 322e, 332e, the second end flange parts 322a, 332a, the third end flange parts 322b, 332b, the fourth end flange parts 322g, 332g, and the fifth end flange parts 322h, 332h are fixed to the frame member 2.

### 5-2. Method for Manufacturing Cross Member

The method for manufacturing the cross member 3E of the fifth embodiment also includes a punching process, a roll forming process, a welding process, a cutting process, and a bending process, similar to the fourth embodiment.

### 5-2-1. Punching Process

The punching process of the fifth embodiment has a configuration substantially similar to that of the fourth embodiment. However, as shown in FIG. 20, an opening group 51E in the punching process of the fifth embodiment has at least one through part having four through holes 511a to 511d and two notches 512d, 512e. In other words, in the punching process of the fifth embodiment, the workpiece 5 is formed with four through holes 511a to 511d and two notches 512d and 512e. In the fifth embodiment, the four through holes 511a to 511d are referred to as the first to fourth through holes 511a to 511d. In the fifth embodiment, the two notches 512d and 512e are referred to as the first notch 512d and the second notch 512e. The first to fourth through holes 511a to 511d, the first notch 512d, and the second notch 512e are arranged in the direction intersecting the length direction D (e.g., perpendicular to the length direction D) in the order of the first notch 512d, the third through hole 511c, the first through hole 511a, the second through hole 511b, the fourth through hole 511d, and the second notch 512e.

FIG. 20 shows, with two-dot chain lines, the positions where the workpiece 5 is bent in the subsequent roll forming process to form the first to sixth ridge parts 314a, 314b, and 314f to 314i.

### 5-2-2. Roll Forming Process

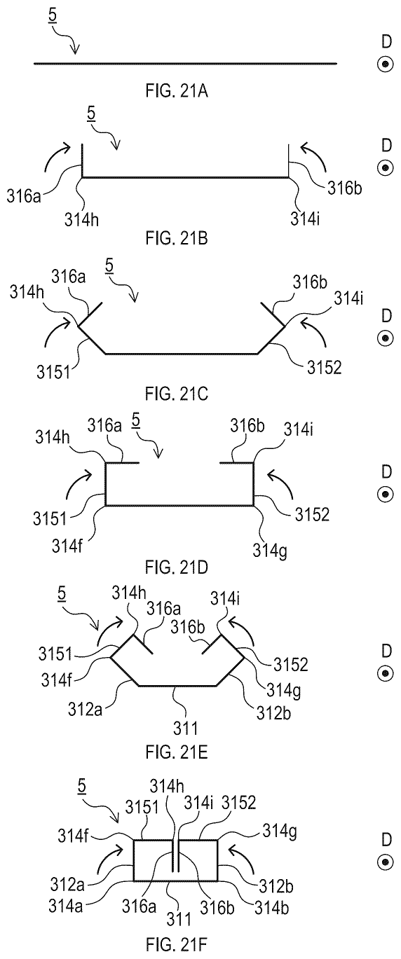

The roll forming process of the fifth embodiment has a configuration substantially similar to that of the fourth embodiment. However, in the roll forming process of the fifth embodiment, as shown in FIGS. 21A to 21F, the first to sixth ridge parts 314a, 314b, and 314f to 314i are formed on the workpiece 5 by roll forming.

More specifically, the workpiece 5 is bent by roll forming as described in steps (A-1), (A-2), (D-1), and (D-2) above, and in steps (E-1) and (E-2) below.

(E-1) As shown in FIG. 21B, the workpiece 5 is bent such that a part corresponding to the first central wall part 316a forms an angle with a part corresponding to the first plate-shaped part 3151. This forms the fifth ridge part 314h on the workpiece 5. As shown in FIG. 22A, the fifth ridge part 314h is formed to overlap the first notch 512d. The fifth ridge part 314h extends along the length direction D.

(E-2) As shown in FIG. 21B, the workpiece 5 is bent such that a part corresponding to the second central wall part 316b forms an angle with a part corresponding to the second plate-shaped part 3152. This forms a sixth ridge part 314i on the workpiece 5. As shown in FIG. 22A, the sixth ridge part 314i is formed to overlap the second notch 512e. The sixth ridge part 314i extends along the length direction D.

The above steps (A-1), (A-2), (D-1), (D-2), (E-1), and (E-2) may be performed individually, or at least two of them may be performed in parallel. In the fifth embodiment, as shown in FIGS. 21A to 21F, steps (E-1) and (E-2) are first performed in parallel. Subsequently, steps (D-1) and (D-2) are performed in parallel. After that, steps (A-1) and (A-2) are performed in parallel. In this case, bending of the workpiece 5 such that the part corresponding to the first central wall part 316a in (E-1) forms an angle with the part corresponding to the first plate-shaped part 3151 can also be said to bending the workpiece 5 such that the part corresponding to the first central wall part 316a faces the part corresponding to the second central wall part 316b.

### 5-2-3. Welding Process

Following the roll forming process, the welding process is performed. In the welding process of the fifth embodiment, as shown in FIGS. 22A and 22B, the fifth ridge part 314h and the sixth ridge part 314i are welded together to form an integrated structure. This forms the welded part 3154, and consequently the opposing wall part 315a, in the workpiece 5. A part of the edge of the workpiece 5 forming the first notch 512d and a part of the edge of the workpiece 5 forming the second notch 512e are continuous with each other by the welded part 3154.

### 5-2-4. Cutting Process

Following the welding process, the cutting process is performed. The cutting process of the fifth embodiment has a configuration substantially similar to that of the fourth embodiment. However, in the fifth embodiment, the opening group 51E has the first to fourth through holes 511a to 511d, the first notch 512d, and the second notch 512e. Therefore, the cutting plane C in the fifth embodiment is a virtual plane passing through the first to fourth through holes 511a to 511d, the first notch 512d, and the second notch 512e, intersecting the length direction D (e.g., perpendicular to the length direction D). Although the cutting plane C of the fifth embodiment is not shown, FIG. 22B indicates, with a two-dot chain line, the position where the cutting plane C intersects the workpiece 5 after the welding process, for reference.

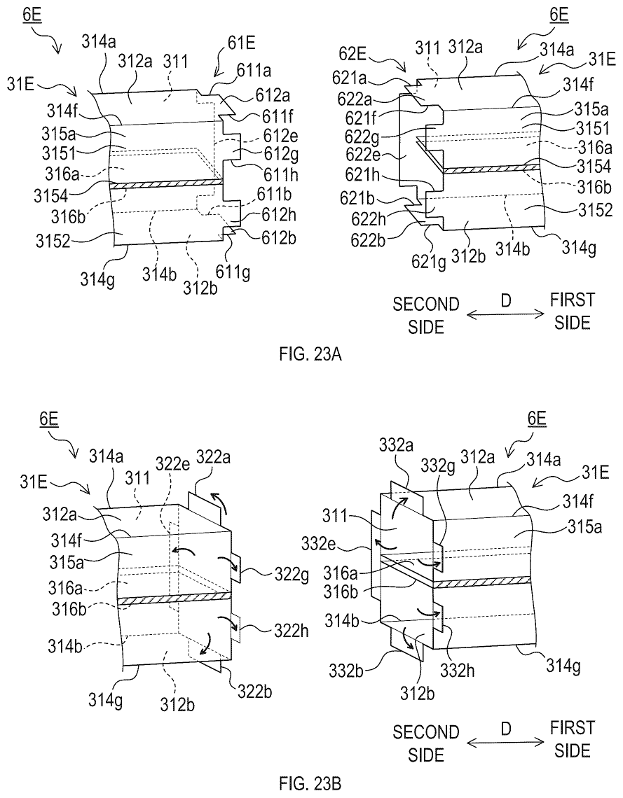

The workpiece 5 is cut at the cutting plane C overlapping each opening group 51E. As a result, a part of the workpiece 5 interposed between the two cutting planes C is obtained as an intermediate formed product 6E shown in FIG. 23A. The intermediate formed product 6E has the above-described main body part 31E, a first cutting end part 61E, and a second cutting end part 62E.

The first cutting end part 61E is provided at the first side end of the main body part 31E. Five notches 611a, 611b, and 611f to 611h are formed in the first cutting end part 61E. In the fifth embodiment, the five notches 611a, 611b, 611f to 611h are referred to as the first to fifth notches 611a, 611b, 611f to 611h, respectively, for distinction. The first to fourth notches 611a, 611b, 611f, and 611g have the same configuration as that in the fourth embodiment. The fifth notch 611h is an opening corresponding to the first notch 512d and the second notch 512e before cutting.

The first cutting end part 61E has five end piece parts 612e, 612a, 612b, 612g, and 612h. In the fifth embodiment, the five end piece parts 612e, 612a, 612b, 612g, and 612h are referred to as the first to fifth end piece parts 612e, 612a, 612b, 612g, and 612h, respectively, for distinction. The first to third end piece parts 612e, 612a, and 612b have the same configuration as that in the fourth embodiment.

The fourth end piece part 612g extends further toward the first side from the first side edge of the first plate-shaped part 3151. The fourth end piece part 612g is plate-shaped (e.g., flat). The fourth end piece part 612g faces the third notch 611f and the fifth notch 611h from the direction perpendicular to the length direction D.

The fifth end piece part 612h extends further toward the first side from the first side edge of the second plate-shaped part 3152. The fifth end piece part 612h is plate-shaped (e.g., flat). The fifth end piece part 612h faces the fourth notch 611g and the fifth notch 611h from the direction perpendicular to the length direction D.

The second cutting end part 62E is provided at the second side end of the main body part 31E. Five notches 621a, 621b, 621f to 621h are formed in the second cutting end part 62E. In the fifth embodiment, the five notches 621a, 621b, 621f to 621h are referred to as the first to fifth notches 621a, 621b, 621f to 621h, respectively, for distinction. The first to fourth notches 621a, 621b, 621f, and 621g have the same configuration as that in the fourth embodiment. The fifth notch 621h is an opening corresponding to the first notch 512d and second notch 512e before cutting.

The second cutting end part 62E has five end piece parts 622e, 622a, 622b, 622g, and 622h. In the fifth embodiment, the five end piece parts 622e, 622a, 622b, 622g, and 622h are referred to as the first to fifth end piece parts 622e, 622a, 622b, 622g, and 622h, respectively, for distinction. The first to third end piece parts 622e, 622a, and 622b have the same configuration as that in the fourth embodiment.

The fourth end piece part 622g extends further toward the second side from the second side edge of the first plate-shaped part 3151. The fourth end piece part 622g is plate-shaped (e.g., flat). The fourth end piece part 622g faces the third notch 621f and the fifth notch 621h from the direction perpendicular to the length direction D.

The fifth end piece part 622h extends further toward the second side from the second side edge of the second plate-shaped part 3152. The fourth end piece part 622g is plate-shaped (e.g., flat). The fourth end piece part 622g faces the third notch 621f and the fifth notch 621h from the direction perpendicular to the length direction D.

### 5-2-5. Bending Process

The bending process of the fifth embodiment has a configuration substantially similar to that of the fourth embodiment. However, in the bending process of the fifth embodiment, as shown in FIGS. 23A and 23B, the first end piece parts 612e, 622e, the second end piece parts 612a, 622a, third end piece parts 612b, 622b, fourth end piece parts 612g, 622g, and fifth end piece parts 612h, 622h are bent. This forms the first end flange parts 322e, 332e, second end flange parts 322a, 332a, third end flange parts 322b, 332b, fourth end flange parts 322g, 332g, and fifth end flange parts 322h, 332h on the intermediate formed product 6E. As a result, the cross member 3E shown in FIG. 19 is obtained.

### 5-3. Effects

According to the fifth embodiment described in detail above, effects similar to those of the fourth embodiment are obtained.

### 6. Sixth Embodiment

### 6-1. Configuration of Cross Member

The sixth embodiment has a basic configuration similar to that of the fifth embodiment; therefore, the differences are described below. Note that the same reference numerals as in the first to fifth embodiments indicate identical configurations, and reference should be made to the preceding description.

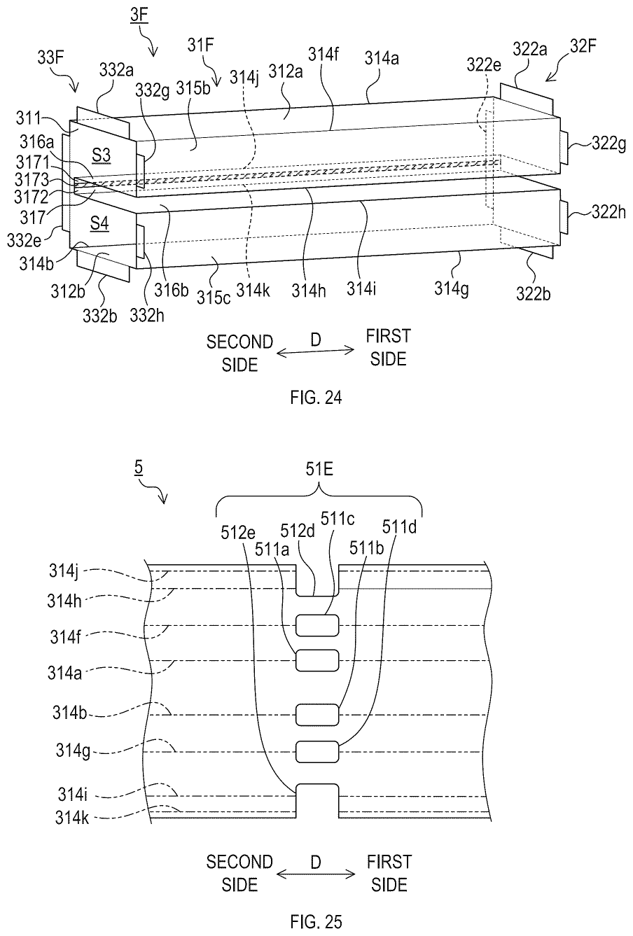

As shown in FIG. 24, a cross member 3F of the sixth embodiment comprises a main body part 31F, a first fixed end part 32F, and a second fixed end part 33F.

The main body part 31F of the sixth embodiment has a configuration substantially similar to that of the main body part 31E of the fifth embodiment. However, the main body part 31F of the sixth embodiment further includes a contact wall part 317. The main body part 31F of the sixth embodiment has two opposing wall parts 315b and 315c instead of the opposing wall part 315a. In the sixth embodiment, the two opposing wall parts 315b and 315c are referred to as the first opposing wall part 315b and the second opposing wall part 315c, respectively, for distinction.

Furthermore, the main body part 31F of the sixth embodiment has eight ridge parts 314a, 314b, 314f to 314k. In the sixth embodiment, the eight ridge parts 314a, 314b, 314f to 314k are referred to as the first to eighth ridge parts 314a, 314b, 314f to 314k, respectively, for distinction. The first to sixth ridge parts 314a, 314b, 314f to 314i are as detailed in the fifth embodiment. However, in the sixth embodiment, the fifth ridge part 314h and the sixth ridge part 314i are not welded to each other. That is, in the sixth embodiment, the fifth ridge part 314h and the sixth ridge part 314i remain on the finished cross member 3F.

The first opposing wall part 315b and second opposing wall part 315c of the sixth embodiment have a configuration substantially similar to that of the opposing wall part 315a of the fifth embodiment. In the fifth embodiment, the opposing wall part 315a is continuous with the first side wall part 312a and the second side wall part 312b via the third ridge part 314f and the fourth ridge part 314g. In contrast, in the sixth embodiment, the first opposing wall part 315b is continuous with the first side wall part 312a via the third ridge part 314f. The second opposing wall part 315c is continuous with the second side wall part 312b via the fourth ridge part 314g. The first opposing wall part 315b and the second opposing wall part 315c are adjacent to each other in the direction perpendicular to the length direction D.

In the sixth embodiment, the first central wall part 316a is continuous with the edge of the first opposing wall part 315b opposite to the first side wall part 312a via the fifth ridge part 314h. The second central wall part 316b is continuous with the edge of the second opposing wall part 315c opposite to the second side wall part 312b via the sixth ridge part 314i. A gap is provided between the first central wall part 316a and the second central wall part 316b.

The contact wall part 317 couples the edge of the first central wall part 316a opposite to the first opposing wall part 315b and the edge of the second central wall part 316b opposite to the second opposing wall part 315c via the seventh ridge part 314j and the eighth ridge part 314k. The contact wall part 317 is plate-shaped (e.g., flat). The contact wall part 317 is in contact with the main body wall part 311.

The contact wall part 317 includes a first plate-shaped part 3171, a second plate-shaped part 3172, and a welded part 3173. The first plate-shaped part 3171 and the second plate-shaped part 3172 are plate-shaped (e.g., flat) parts. The first plate-shaped part 3171 is continuous with the first central wall part 316a via the seventh ridge part 314j. The second plate-shaped part 3172 is continuous with the second central wall part 316b via the eighth ridge part 314k. The first plate-shaped part 3171 and the second plate-shaped part 3172 are adjacent to each other in the direction perpendicular to the length direction D. The welded part 3173 is a part where opposing end faces of the first plate-shaped part 3171 and the second plate-shaped part 3172 are welded together.

Similar to the fifth embodiment, a cross section of the main body part 31F in the direction perpendicular to the length direction D is substantially B-shaped. In the sixth embodiment, the internal space S3 is a space surrounded on all four sides by the main body wall part 311, the first side wall part 312a, the first opposing wall part 315b, and the first central wall part 316a. In the sixth embodiment, the internal space S4 is a space surrounded on all four sides by the main body wall part 311, the second side wall part 312b, the second opposing wall part 315c, and the second central wall part 316b.

The first fixed end part 32F of the sixth embodiment has a configuration substantially similar to that of the first fixed end part 32E of the fifth embodiment. However, in the sixth embodiment, the fourth end flange part 322g extends from the first side edge of the first opposing wall part 315b toward the outer side of the main body part 31F. The fifth end flange part 322h extends from the first side edge of the second opposing wall part 315c toward the outer side of the main body part 31F.

The second fixed end part 33F of the sixth embodiment has a configuration substantially similar to that of the second fixed end part 33E of the fifth embodiment. However, in the sixth embodiment, the fourth end flange part 332g extends from the second side edge of the first opposing wall part 315b toward the outer side of the main body part 31F. The fifth end flange part 332h extends from the second side edge of the second opposing wall part 315c toward the outer side of the main body part 31F.

The cross member 3F of the sixth embodiment is fixed to the frame member 2 in the same manner as in the fifth embodiment.

### 6-2. Method for Manufacturing Cross Member

The method for manufacturing the cross member 3F of the sixth embodiment also includes a punching process, a roll forming process, a welding process, a cutting process, and a bending process, as in the fifth embodiment.

### 6-2-1. Punching Process

As shown in FIG. 25, the punching process of the sixth embodiment has the same configuration as the punching process of the fifth embodiment. FIG. 25 shows, with two-dot chain lines, the positions where the workpiece 5 is bent in the subsequent roll forming process to form the first to eighth ridge parts 314a, 314b, 314f to 314k.

### 6-2-2. Roll Forming Process

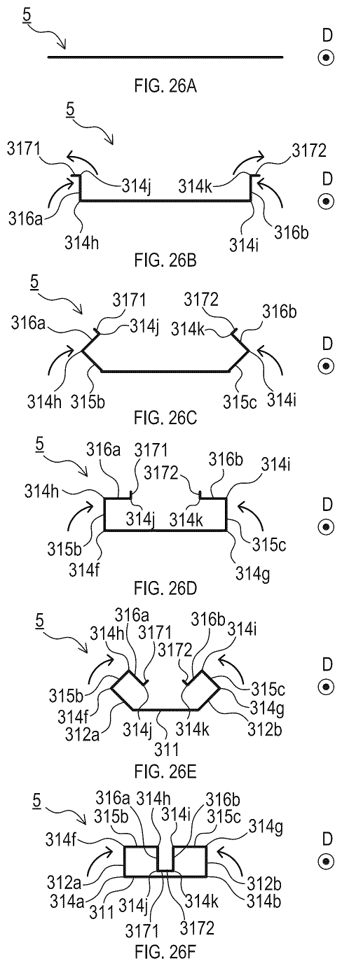

The roll forming process of the sixth embodiment has a configuration substantially similar to that of the roll forming process of the fifth embodiment. However, in the roll forming process of the sixth embodiment, as shown in FIGS. 26A to 26F, the first to eighth ridge parts 314a, 314b, 314f to 314k are formed on the workpiece 5 by roll forming.

More specifically, the workpiece 5 is bent by roll forming as described in steps (A-1), (A-2), (D-1), (D-2), (E-1), and (E-2) above, and as described in steps (F-1) and (F-2) below. Here, in the sixth embodiment, the first plate-shaped part 3151 in step (E-1) shall be read as the first opposing wall part 315b, and the second plate-shaped part 3152 in (E-2) shall be read as the second opposing wall part 315c.

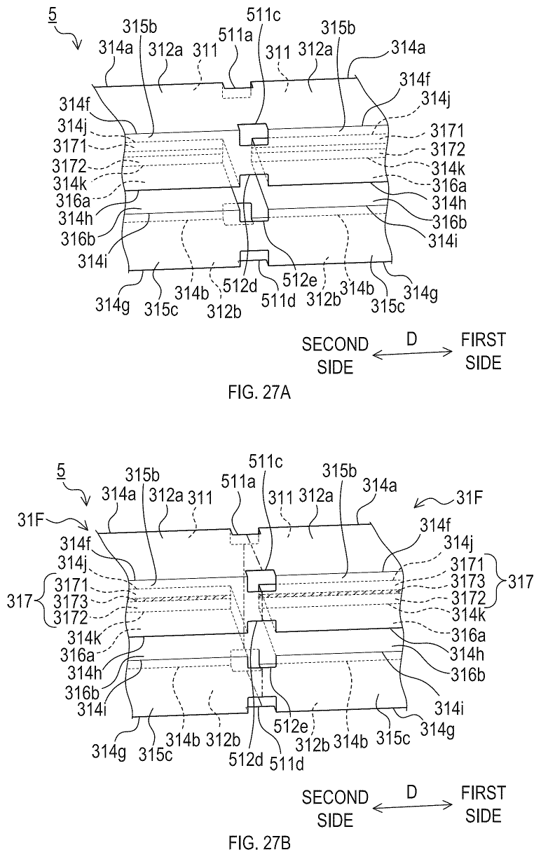

(F-1) As shown in FIG. 26B, the workpiece 5 is bent such that a part corresponding to the first plate-shaped part 3171 forms an angle with a part corresponding to the first central wall part 316a. This forms the seventh ridge part 314j on the workpiece 5. As shown in FIGS. 25 and 27A, the seventh ridge part 314j is formed to overlap the first notch 512d. The seventh ridge part 314j extends along the length direction D.

(F-2) As shown in FIG. 26B, the workpiece 5 is bent such that a part corresponding to the second plate-shaped part 3172 forms an angle with a part corresponding to the first central wall part 316b. This forms the eighth ridge part 314k on the workpiece 5. As shown in FIGS. 25 and 27A, the eighth ridge part 314k is formed to overlap the second notch 512e. The eighth ridge part 314k extends along the length direction D.

The above steps (A-1), (A-2), (D-1), (D-2), (E-1), (E-2), (F-1), and (F-2) may be performed individually, or at least two of them may be performed in parallel. As shown in FIGS. 26A to 26F, in the sixth embodiment, these steps are performed in an order substantially similar to that of the fifth embodiment. However, as shown in FIG. 26B, steps (E-1) and (E-2) are performed in parallel with steps (F-1) and (F-2).

### 6-2-3. Welding Process

Following the roll forming process, the welding process is performed. In the welding process of the sixth embodiment, as shown in FIGS. 27A and 27B, the opposing end faces of the first plate-shaped part 3171 and the second plate-shaped part 3172 are welded together. This forms the welded part 3173 on the workpiece 5. The welded part 3173 couples the first plate-shaped part 3151 and the second plate-shaped part 3152, thereby forming the contact wall part 317 in the workpiece 5.

### 6-2-4. Cutting Process

Following the welding process, the cutting process is performed. The cutting process of the sixth embodiment has a configuration similar to that of the fifth embodiment. Although the cutting plane C of the sixth embodiment is not shown, FIG. 27B indicates, with a two-dot chain line, the position where the cutting plane C intersects the workpiece 5 after the welding process, for reference.

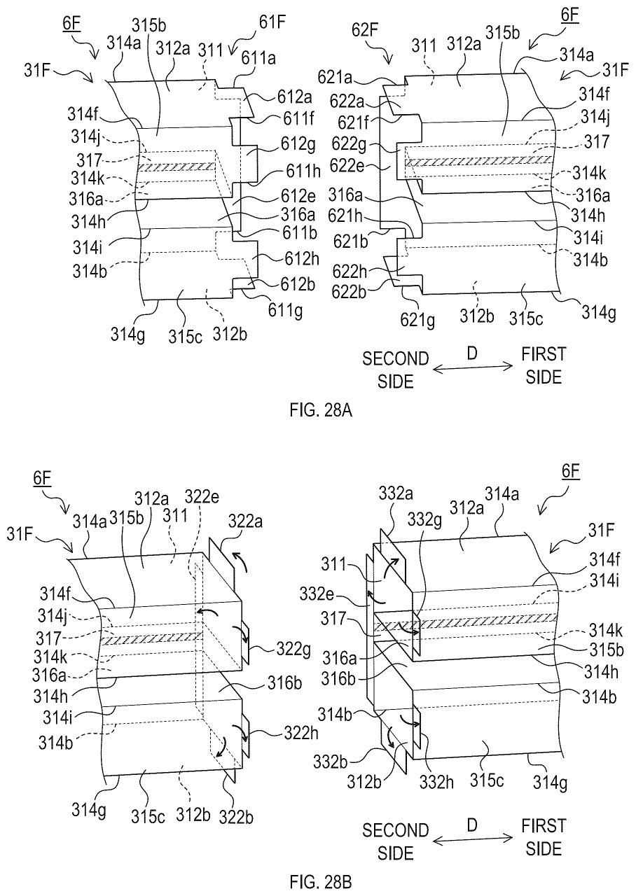

The workpiece 5 is cut at the cutting plane C overlapping each opening group 51E. As a result, a part of the workpiece 5 interposed between the two cutting planes C is obtained as an intermediate formed product 6F shown in FIG. 28A. The intermediate formed product 6F has the above-described main body part 31F, a first cutting end part 61F, and a second cutting end part 62F.

The first cutting end part 61F of the sixth embodiment has a configuration substantially similar to that of the first cutting end part 61E of the fifth embodiment. However, in the first cutting end part 61F of the sixth embodiment, the fourth end piece part 612g extends further toward the first side from the first side edge of the first opposing wall part 315b. The fifth end piece part 612h extends further toward the first side from the first side edge of the second opposing wall part 315c.

The second cutting end part 62F of the sixth embodiment has a configuration substantially similar to that of the second cutting end part 62E of the fifth embodiment. However, in the second cutting end part 62F of the sixth embodiment, the fourth end piece part 622g extends further toward the second side from the second side edge of the first opposing wall part 315b. The fifth end piece part 622h extends further toward the second side from the second side edge of the second opposing wall part 315c.

### 6-2-5. Bending Process

Following the cutting process, the bending process is performed. The bending process in the sixth embodiment has a configuration substantially similar to that of the fifth embodiment. As shown in FIGS. 28A and 28B, the first end piece parts 612e, 622e, the second end piece parts 612a, 622a, the third end piece parts 612b, 622b, the fourth end piece parts 612g, 622g, and the fifth end piece parts 612h, 622h are bent. This forms the first end flange parts 322e, 332e, the second end flange parts 322a, 332a, the third end flange parts 322b, 332b, the fourth end flange parts 322g, 332g, and the fifth end flange parts 322h, 332h on the intermediate formed product 6F. As a result, the cross member 3F shown in FIG. 24 is obtained.

### 6-3. Effects

According to the sixth embodiment described in detail above, effects similar to those of the fifth embodiment are obtained.

### 7. Other Embodiments

The embodiments of the present disclosure have been described in the above. The present disclosure is not limited to the above-described embodiments and may take various forms.

(7a) In the cross members 3A to 3F of the above first to sixth embodiments, a plural number of end flange parts 322a to 322h and 332a to 332h are provided at each of the first-side end and second-side end of the main body part 31A to 31F. However, the number of end flange parts provided at the first side end or the second side end of the main body part is not particularly limited. For example, only one end flange part may be provided at the first side end or the second side end of the main body part.

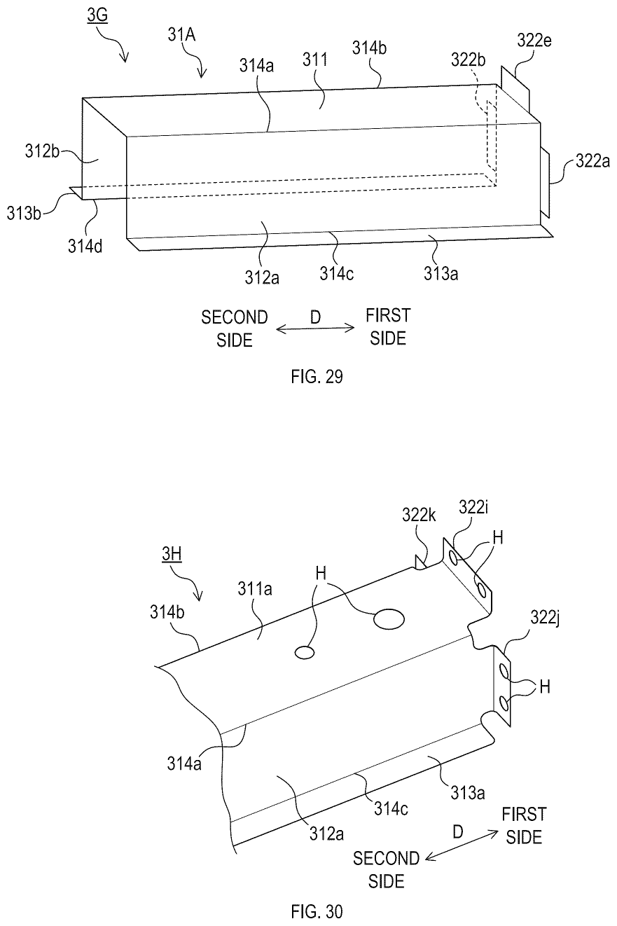

(7b) In the cross members 3A to 3F of the above first to sixth embodiments, at least one end flange part 322a to 322h, 332a to 332h is provided on both the first side end and the second side end of the main body part 31A to 31F. However, at least one end flange part may be provided only at one end in the length direction. For example, in a cross member 3G shown in FIG. 29, the end flange parts 322a, 322b, and 322e are provided only at the first side end of the main body part 31A.

(7c) For example, as shown in FIG. 30, an additional through part H, such as a through hole, may be formed in at least one of the main body wall part 311a and the end flange parts 322i to 322k of a cross member 3H. For example, the additional through part H may be formed in a part other than the main body wall part and the end flange part, such as the side wall part of the cross member. The additional through part H is used, for example, to insert a fastening member such as a bolt. An example method for manufacturing such a cross member includes forming the additional through part H simultaneously when an opening group is formed during a punching process.

(7d) The cross members 3A to 3F of the above first to sixth embodiments are examples of formed products. However, the formed products are not necessarily limited to cross members disposed inside a frame member.

For example, the formed product may be a floor cross member or a side member forming a floor of the vehicle. The floor cross member is mounted on the vehicle, for example, extending in the left-right direction of the vehicle. The side member is mounted on the vehicle, for example, extending in the front-rear direction of the vehicle. Even when the formed product is a floor cross member or a side member, it may be necessary to vary the dimension in the length direction D of the main body part in accordance with the overall length or width of the vehicle. Therefore, it is useful to achieve the effect described in (1b) above.

Furthermore, for example, the formed product does not necessarily have to be a component mounted on the vehicle.

(7e) A function possessed by one component in the above-described embodiments may be divided into multiple components, or functions possessed by multiple components may be integrated into a single component. Furthermore, part of the configuration of the above-described embodiments may be omitted. Also, at least part of the configuration of any of the above-described embodiments may be added to, or replaced by, the configuration of another of the above-described embodiments.

(7f) The present disclosure may be achieved in various forms, including not only the above-described cross members 3A to 3H, but also a battery mounting structure 1 comprising the cross members 3A to 3H as components, a method for manufacturing the cross members 3A to 3H, and the like.

What is claimed is:

1. A method for manufacturing a formed product,
the formed product comprising:
a plate-shaped main body part extending in a length direction of the formed product and having at least one ridge part formed along the length direction; and
at least one flange part provided at an end of the main body part in the length direction,
the method comprising:
bending by roll forming a plate-shaped workpiece, which extends in the length direction and has at least one through part formed therethrough, to form the at least one ridge part on the workpiece such that the at least one ridge part overlaps the at least one through part;
cutting the workpiece, which has the at least one ridge part formed thereon, along a cutting plane intersecting the length direction through the at least one through part, thereby obtaining an intermediate formed product including the main body part and at least one end piece part facing the at least one through part from a direction perpendicular to the length direction; and
bending the at least one end piece part to form the at least one flange part on the intermediate formed product, thereby obtaining the formed product.

2. The method according to claim 1, further comprising:
forming the at least one through part in the workpiece before bending the workpiece by roll forming.

3. The method according to claim 1,
wherein the workpiece includes, as the at least one through part, multiple through parts arranged in a direction intersecting the length direction, and includes, as the at least one ridge part, multiple ridge parts formed such that each ridge part overlaps with one of the multiple through parts, and
wherein cutting the workpiece along the cutting plane overlapping the multiple through parts produces the intermediate formed product.

4. The method according to claim 3, further comprising:
forming the multiple through parts as the at least one through part in the workpiece before bending the workpiece by roll forming.

5. The method according to claim 1, wherein the workpiece is high-tensile steel.

6. The method according to claim 1, wherein the formed product is a component mounted on a vehicle.
